(19) United States
(12) Patent Application Publication
(10) Pub. No.: US 2007/0277011 A1
(43) Pub. Date: Nov. 29, 2007

(54) Storage system and data management method

(76) Inventors: Hiroyuki Tanaka, Fujisawa (JP); Mikihiko Tokunaga, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/492,760

(22) Filed: Jul. 26, 2006

(30) Foreign Application Priority Data
May 26, 2006 (JP) 2006-146764

(51) Int. Cl. G06F 12/16

(52) U.S. Cl. 711/162

(57) ABSTRACT

Provided are a storage system and a data management method capable of improving the responsiveness of data that is periodically and frequently accessed without adversely affecting the data I/O processing. This storage system monitors the access frequency of a host system to a volume and copies the data stored in the volume to a volume with a response speed that is faster than the volume when the access frequency exceeds a first default value, switches the access destination of the host system to the volume of a copy source to the volume of a copy destination, writes data to be written in both the volume of the copy destination and the volume of the copy source when there is a write access from the host system to the volume of the copy destination, and returns the access destination of the host system to the volume of the copy source to the volume of the copy destination when the access frequency of the host system to the volume of the copy destination falls below a second default value.

### CROSS-REFERENCES TO RELATED APPLICATIONS

This application relates to and claims priority from Japanese Patent Application No. 2006-146764, filed on May 26, 2006, the entire disclosure of which is incorporated herein by reference.

### BACKGROUND

The present invention relates to a storage system and a data management method, and, for instance, can be suitably applied to a storage system for storing data that is periodically accessed.

The cost per storage capacity is more expensive when the response speed is fast and less expensive when the response speed is slow. There is difference in the access frequency to data stored in the storage depending on the type of data, and there is data which is accessed frequency, and there is data which is rarely accessed and has a long access interval. By storing data with a high access frequency in a logical volume set in a storage extent provided by a high-speed storage and storing data with a low access frequency in a logical volume set in a storage extent provided by a low-speed storage, it is possible to reduce the system cost without deteriorating the access performance.

Among the data with a low access frequency, there is data that is periodically and frequently accessed. For instance, this would be data that is accessed only during data tabulation times such as at the end of each month or end of each fiscal year. Nevertheless, since the data with a low access frequency is stored in a logical volume set in a storage extent provided by a low-speed storage, there is a problem in that the responsiveness will deteriorate.

Thus, conventionally, a storage apparatus was proposed which copies beforehand the data stored in a low-speed storage to a high-speed storage when the use of such data is expected so as to enable access to a high-speed storage with a fast response speed, and not to a low-speed storage, during the actual use of such date. In addition, this storage apparatus secured unused capacity in an expensive high-speed storage medium by migrating non-periodical data from a high-speed storage to a low-speed storage (refer to Japanese Patent Laid-Open Publication No. 2003-216460).

### SUMMARY

Nevertheless, when using the foregoing storage apparatus, all data that departs from the cycle must be migrated from a high-speed storage to a low-speed storage after such data departs from the cycle, and there is a problem in that the load on the controller of the storage apparatus will become significant, and this will adversely affect the data I/O processing to the data I/O request from the host system during the migration of data.

Further, when all data of the high-speed storage and all data of the low-speed storage do not coincide, all data of the high-speed storage must be migrated to the low-speed storage. Nevertheless, when migrating all data as described above, this will mean that data that is overlapping with the data that is already stored in the low-speed storage will be stored once again in the low-speed storage. Thus, there is a problem in that the capacity load for storing the data will increase and burden will be placed on the storage capacity of the low-speed storage. Moreover, there is another problem in that the backup processing of data and the data I/O request from the host system will compete and aggravate the responsiveness of the storage to the data I/O request.

The present invention was made in view of the foregoing problems. Thus, an object of this invention is to provide a storage system and a data management method capable of improving the responsiveness of data that is periodically and frequently accessed without adversely affecting the data I/O processing.

In order to achieve the foregoing object, the present invention provides a storage system having a host system as a higher-level device, and a storage apparatus providing a volume for the host system to write data. This storage system comprises an access frequency monitoring unit for monitoring the access frequency of the host system to the volume provided by the storage apparatus, and a data management unit for managing the data written in the volume based on the monitoring result of the access frequency monitoring unit. The data management unit copies the data stored in the volume to a volume with a response speed that is faster than the volume when the access frequency of the host system to the volume exceeds a first default value, switches the access destination of the host system to the volume of a copy source to the volume of a copy destination, writes data to be written in both the volume of the copy destination and the volume of the copy source when there is a write access from the host system to the volume of the copy destination, and returns the access destination of the host system to the volume of the copy source to the volume of the copy destination when the access frequency of the host system to the volume of the copy destination falls below a second default value.

Thereby, with this storage system, since data is migrated to a volume with faster responsiveness based on the access frequency to such data, it is possible to improve the responsiveness to data that is periodically and frequently accessed from such volume. Further, with this storage system, since the data written in the volume of the copy destination is also written in the volume of the copy source, and the copy source of the access destination of the host system is returned to the volume of the copy destination at the stage when the access frequency to the volume of the copy destination is reduced, there is no need to migrate data of the copy destination volume to the copy source volume, and it is therefore possible to prevent the adverse affect resulting from migrating the data of the copy destination volume to the copy source volume.

Further, the present invention provides a data management method in a storage system having a host system as a higher-level device, and a storage apparatus providing a volume for the host system to write data. This data management method comprising the steps of monitoring the access frequency of the host system to the volume provided by the storage apparatus, and managing the data written in the volume based on the monitoring result of the access frequency monitoring unit. At the managing step, the data stored in the volume is copied to a volume with a response speed that is faster than the volume when the access frequency of the host system to the volume exceeds a first default value, the access destination of the host system to the volume of a copy source is switched to the volume of a copy destination, data to be written is written in both the volume of the copy destination and the volume of the copy source when there is a write access from the host system to the volume of the copy destination, and the access destination of the host system is returned to the volume of the copy source to the volume of the copy destination when the access frequency of the host system to the volume of the copy destination falls below a second default value.

Thereby, with this data management method, since data is migrated to a volume with faster responsiveness based on the access frequency to such data, it is possible to improve the responsiveness to data that is periodically and frequently accessed from such volume. Further, with this data management method since the data written in the volume of the copy destination is also written in the volume of the copy source, and the copy source of the access destination of the host system is returned to the volume of the copy destination at the stage when the access frequency to the volume of the copy destination is reduced, there is no need to migrate data of the copy destination volume to the copy source volume, and it is therefore possible to prevent the adverse affect resulting from migrating the data of the copy destination volume to the copy source volume.

According to the present invention, it is possible to realize a storage system and a data management method capable of improving the responsiveness of data that is periodically and frequently accessed without adversely affecting the data I/O processing.

### DESCRIPTION OF DRAWINGS

FIG. 1 is a block diagram showing the storage system 1 according to an embodiment of the present invention;

FIG. 2 is a block diagram showing the configuration of the storage apparatus 3 inside the storage system 1 according to an embodiment of the present invention;

FIG. 3 is a conceptual diagram showing the path connection information table 14;

FIG. 4 is a conceptual diagram showing the copy management table 45;

FIG. 5 is a conceptual diagram showing the access management table 46;

FIG. 6 is a conceptual diagram showing the device management table 32;

FIG. 7 is a conceptual diagram showing the volume host management table 48;

FIG. 8 is a conceptual diagram showing the access count management table 29;

FIG. 9 is a conceptual diagram showing the hierarchy-based volume management table 30A;

FIG. 10 is a conceptual diagram showing the hierarchy-based volume management table 30B;

FIG. 11 is a conceptual diagram showing the setting table 31;

FIG. 12 is a conceptual diagram showing the volume management table 32;

FIG. 13 is a plan view explaining the referral destination volume switching processing setting/execution screen 300;

FIG. 14 is a conceptual diagram explaining the volume hierarchy/storage selection unit 302 in the referral destination volume switching processing setting/execution screen 300;

FIG. 15 is a plan view explaining the referral destination volume switching processing setting/execution screen 300;

FIG. 16 is a conceptual diagram explaining the threshold value of the access frequency in the access right setting column 307 of the referral destination volume switching processing setting/execution screen 300;

FIG. 17 is a plan view explaining the referral destination volume switching processing setting/execution screen 300;

FIG. 18A to FIG. 18D are conceptual diagrams explaining the referral destination volume switching processing pertaining to the pair status according to an embodiment of the present invention;

FIG. 19A to FIG. 19D are conceptual diagrams explaining the referral destination volume switching processing pertaining to the non-pair status according to an embodiment of the present invention;

FIG. 20A to FIG. 20C are conceptual diagrams explaining the referral destination volume switching processing to the difference status according to an embodiment of the present invention;

FIG. 21 is a conceptual diagram explaining the referral destination volume switching processing pertaining to the non-pair status according to an embodiment of the present invention;

FIG. 22 is a conceptual diagram explaining the referral destination volume switching processing in a difference type according to an embodiment of the present invention;

FIG. 23 is a conceptual diagram explaining the referral destination volume switching processing in a difference type according to an embodiment of the present invention;

FIG. 24 is a flowchart explaining the screen display program 28 in the storage system 1;

FIG. 25 is a flowchart explaining a subprogram in the storage system 1;

FIG. 26 is a flowchart explaining the access monitoring program 22 in the storage system;

FIG. 27 is a flowchart explaining the volume change processing program 23 in the storage system 1;

FIG. 28 is a flowchart explaining the pair type volume creation processing program 33 in the storage system 1;

FIG. 29 is a flowchart explaining the non-pair type volume creation processing program 34 in the storage system 1;

FIG. 30 is a flowchart explaining the difference type volume creation processing program 35 in the storage system 1;

FIG. 31 is a flowchart explaining the copy volume monitoring program 25 in the storage system 1;

FIG. 32 is a flowchart explaining the volume release processing program 24 in the storage system 1;

FIG. 33 is a flowchart explaining the pair type volume release processing program 24 in the storage system 1;

FIG. 34 is a flowchart explaining the non-pair type volume release processing program 24 in the storage system 1;

FIG. 35 is a flowchart explaining the difference type volume release processing program 24 in the storage system 1;

FIG. 36 is a flowchart explaining the flow of data I/O between the host system 2 and logical volume VOL in the difference pair status of the storage system 1;

FIG. 37 is a flowchart explaining the path switching program 26 in the storage system 1; and

FIG. 38 is a conceptual diagram explaining a case where logical volumes VOL are respectively provided in different storage apparatuses 3.

### DETAILED DESCRIPTION

An embodiment of the present invention is now explained with reference to the attached drawings.

### (1) Overall Configuration of Storage System

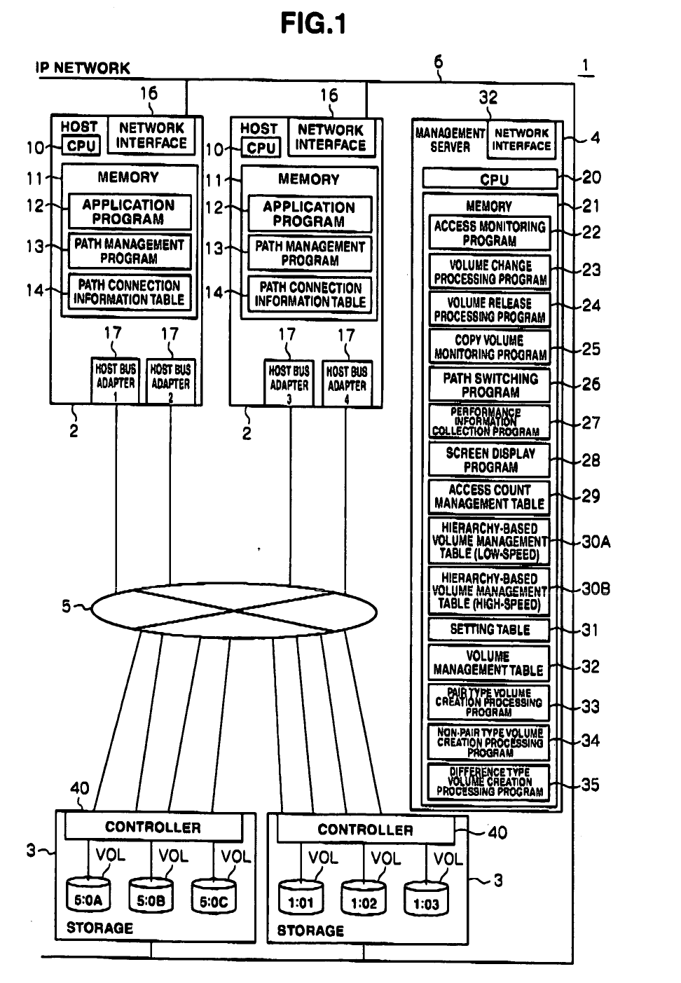

FIG. 1 shows the overall storage system 1 according to an embodiment of the present invention. The storage system 1 is configured by a plurality of host systems 2 being connected to a plurality of storage apparatuses 3 via a network 5, and the respective host systems 2, respective storage apparatuses 3 and a management server being connected with an IP network 6.

The host system 2 as a higher-level system is a computer device comprising information processing resources such as a CPU (Central Processing Unit) 10 and a memory 11, and, for instance, is configured from a personal computer, workstation, or mainframe. The host system 2 has an information input device (not shown) such as a keyboard, switch, pointing device or microphone, and an information output device (not shown) such as a monitor display or speaker.

The CPU 10 is a processor for governing the control of the overall operation of the host system 2. The memory 11 is used for retaining an application program 12 used in the user's business, and is also used as a work memory of the CPU 10. Various types of processing is performed by the overall host system 2 as a result of the CPU 10 executing the application program 12 retained in the memory 11. A path management program 13 and a path connection information table 14 described later are also stored in the memory 11.

A network interface 16 is configured from a network interface card, and is used as an I/O adapter for connecting the host system 2 to the IP network 6.

A host bus adapter (HBA) 17 is used for providing an interface and bus for delivering data from an external storage apparatus to the host bus. A fibre channel or SCSI cable is connected to the host system 2 via the host bus adapter 17.

The network 5, for example, is configured from a SAN, LAN, the Internet, dedicated line or public line. Communication between the host system 2 and the storage apparatus 3 via the network 5 is conducted according to a fibre channel protocol when the network 5 is a SAN, and conducted according to a TCP/IP (Transmission Control Protocol/Internet Protocol) protocol when the network 5 is a LAN.

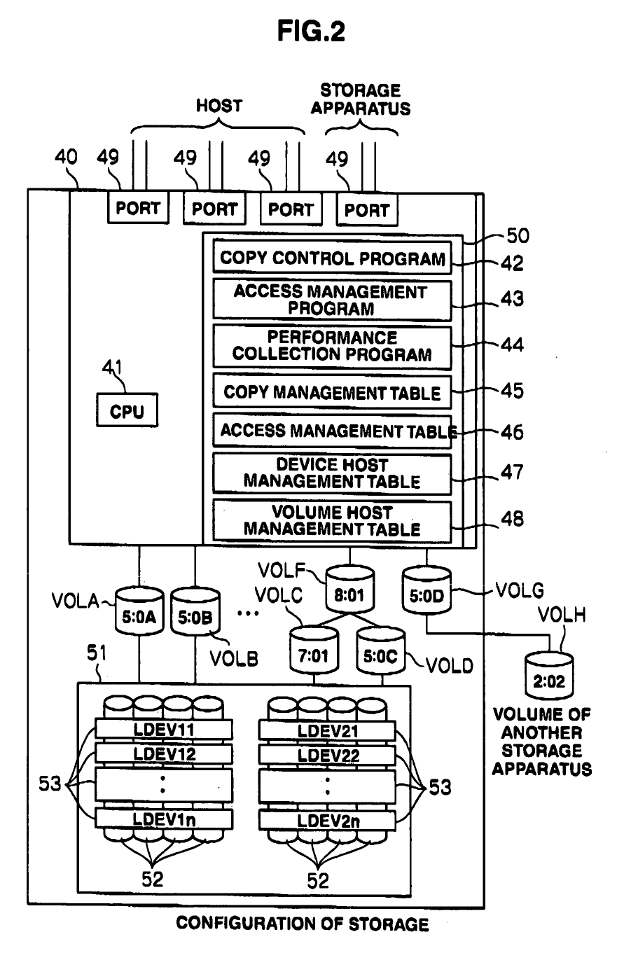

The storage apparatus 3, as shown in FIG. 2, comprises a disk device unit 51 configured from a plurality of disk devices 52 respectively storing data, and a control unit 40 for controlling the input and output of data to and from the disk device unit 51.

The disk devices 52, for instance, are configured from an expensive disk drive such as a SCSI (Small Computer System Interface) disk or an inexpensive disk drive such as a SATA (Serial AT Attachment) disk or an optical disk.

The disk devices 52 are operated according to a RAID system by the control unit 40. One or more logical devices (LDEV) 53 are configured on a physical storage extent provided by one or more disk devices 52. A logical volume (this is hereinafter referred to as a “logical volume”) VOL is defined by one or more logical devices. Data from the host system 2 is stored in the logical volume in block units of a prescribed size (this is hereinafter referred to as a “logical block”).

Incidentally, a logical volume VOL set on a storage extent provided by a disk device having a low response speed is hereinafter referred to as a “low-speed logical volume VOL”, and a logical volume VOL set on a storage extent provided by a disk device having a high response speed is hereinafter referred to as a “high-speed logical volume VOL”.

Each logical volume VOL is assigned a unique volume number. In the case of this embodiment, the volume number and a unique number (LBA: Logical Block Address) allocated to each block are set as the address, and the input and output of user data is conducted by designating such address.

Meanwhile, the control unit 40 comprises a port 49, a CPU 41, a memory 50 and the like. The control unit 40 is connected to the host system 2 and another storage apparatus 3 through the port 49 and via the network 5.

The CPU 41 is a processor for controlling the various types of processing such as data I/O processing to the disk device 52 in response to a write access request or a read access request from the host system 2.

The memory 50 is used for retaining various control programs, and is also used as a work memory of the CPU 41. A copy control program 42, an access management program 43, a performance collection program 44, a copy management table 45, an access management table 46, a device management table 47, and a volume host management table 48 described later are also stored in the memory 50.

The management server 4 is a server for monitoring and managing the storage apparatus 3, comprises information processing resources such as a CPU 20 and a memory 21, and functions as a data management unit for managing data written in the logical volume VOL. The host system 2 and the storage apparatus 3 are connected through the network interface 32 and via the IP network 6.

The CPU 20 is a processor for governing the control of the overall operation of the management server 4. The memory 21 is used for retaining various control programs, and is also used as a work memory of the CPU 20. An access monitoring program 22, a volume change processing program 23, a volume release processing program 24, a copy volume monitoring program 25, a path switching program 26, a performance information collection program 27, a screen display program 28, a pair type volume creation processing program 33, a non-pair type volume creation processing program 34, and a difference type volume creation processing program 35 described later, and a access count management table 29, as well as a hierarchy-based volume management tables 30A and 30B, a setting table 31, and a volume management table 32 described later are also stored in the memory 21.

The network interface 16 is configured from a network interface card such as a SCSI card, and is used as the I/O adapter for connecting the management server 4 to the IP network 6.

### (2) Referral Destination Volume Switching Function of Present Embodiment

### (2-1) Description of Referral Destination Volume Switching Function and Configuration of Respective Tables

The referral destination volume switching function adopted by the storage system 1 is now explained.

The storage system 1 is adopting a referral destination volume switching function of monitoring the access frequency of the host system 2 to the respective low-speed logical volumes VOL set in the storage apparatus 3, and, when the access frequency to the low-speed logical volume VOL or a storage apparatus (this is hereinafter referred to as “low-speed storage apparatus”) 3 with a low response speed becomes high, copying the data stored in such low-speed logical volume VOL or low-speed storage apparatus 3 to a high-speed logical volume VOL or a storage apparatus (this is hereinafter referred to as “high-speed storage apparatus”) 3 with a high response speed, and temporarily switching the referral destination of access to the low-speed logical volume VOL or the low-speed storage apparatus 3 to the high-speed logical volume VOL or the high-speed storage apparatus 3.

In the case of this storage system 1, as the pair status of the copy pair of the low-speed logical volume VOL (including the logical volume VOL in the low-speed storage apparatus 3) and the high-speed logical volume VOL (including the logical VOL in the high-speed storage apparatus 3) upon copying the data stored in the low-speed logical volume VOL or the low-speed storage apparatus 3 to the high-speed logical volume VOL or the high-speed storage apparatus 3, it is possible to select one pair status desired by the user in advance among three modes: namely, pair type, non-pair type and difference type.

Here, a pair type refers to the pair status of a case where data is written from the host system 2 to the high-speed logical volume VOL after switching the referral destination from the low-speed logical volume VOL to the high-speed logical volume VOL as described above, and this is also reflected in the low-speed logical volume VOL (similarly writing such data in the low-speed logical volume VOL).

Further, a non-pair type refers to the pair status where the writing of data from the host system 2 to the high-speed logical volume VOL is not reflected in the low-speed logical volume VOL (such data is not written in the low-speed logical volume VOL). Moreover, a difference type refers to the pair status where the writing of data from the host system 2 to the high-speed logical volume VOL is not reflected in the low-speed logical volume VOL, and such data is managed as difference data.

The storage system 1 is capable of performing appropriate referral destination volume switching processing by enabling the selection of one pair status desired by the user in advance among three modes; namely, pair type, non-pair type and difference type.

As means for performing the various types of processing relating to this referral destination volume switching function, a path management program 13 and a path connection information table 14 are stored in the memory 11 of the host system 2 as described above.

The path management program 13 is a program for managing the volume numbers corresponding to the respective data transfer paths (these are hereinafter referred to as “paths”) using a path connection information table 14 and a device management table 47 described later. The CPU 10 (FIG. 1) of the host system 2 manages the volume number corresponding to the path ID (identifier) of the respective paths using existing methods based on the path management program 13.

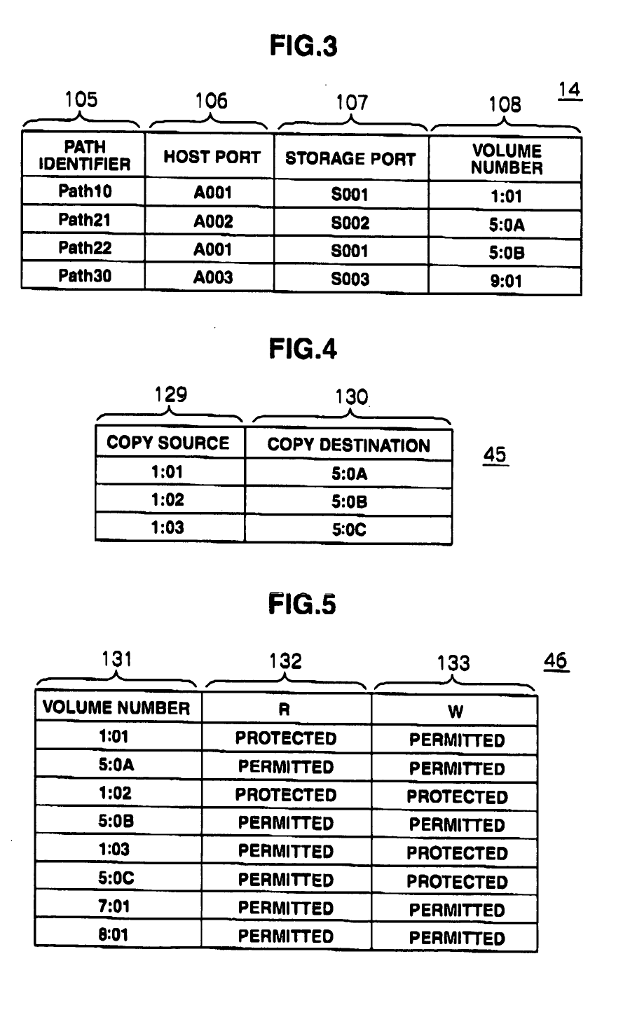

The path connection information table 14 is a table used for managing the volume number corresponding to the path ID of the device management table 47, and, as shown in FIG. 3, is configured from a “path identifier” field 105, a “host port” field 106, a “storage port” field 107, and a “volume number” field 108.

The “path identifier” field 105 stores the path IDs given to the respective paths between the host system 2 and the storage apparatuses 3. The “host port” field 106 stores the port ID of the port 49 of the host system 2 connected to the corresponding path.

The “storage port” field 107 stores the port ID of the port 49 of the storage apparatus 3 to which the path is connected, and the “volume number” field 10B stores the volume number of the logical volume VOL in the storage apparatus 3 to which the host system 2 is connected in an accessible state via the path.

Accordingly, in the example shown in FIG. 3, for instance, a path given a path ID of “Path 10” or is connecting the host port “A001” and the storage port “S001”, and the host system 2 is able to access the logical volume VOL having a volume number of “1:01” through such path.

The memory 50 of the storage apparatus 3 stores various control programs such as the copy control program 42, the access management program 43, and the performance collection program 44, and various management tables such as the copy management table 45, the access management table 46, the device management table 47, and the volume host management table 48.

Among the above, the copy control program 42 is a program for copying all data stored in a certain logical volume VOL to a different logical volume VOL. The CPU 41 (FIG. 2) of the storage apparatus 3 controls the copying of data between the logical volumes VOL using existing methods based on the copy control program 42.

The access management program 43 is a program for setting the access right in the logical volume VOL and referring to such access right. The performance collection program 44 is a program for collecting various types of information relating to the performance of the storage apparatus 3 such as the access count to the logical volume VOL. The CPU 41 of the storage apparatus 3 sets the access right in the logical volume VOL and refers to such access right, and collects various types of information relating to the performance of the storage apparatus 3 using existing methods based on the access management program 43 and the performance collection program 44.

The copy management table 45 is a table for managing the copy pair where the logical volume VOL set in one's own storage apparatus 3 is a copy source and/or a copy destination, and, as shown in FIG. 4, is configured from a “copy source” field 129 and a “copy destination” field 130.

The “copy source” field 129 stores the volume number of the logical volume (for instance the low-speed logical volume) VOL set as the copy source among such copy pair. The “copy destination” field 130 stores the volume number of the logical volume (for instance the high-speed logical volume) VOL set as the copy destination of the copy pair.

Accordingly, in the example shown in FIG. 4, for instance, a copy pair is formed with a logical volume VOL having a volume number of “1:01” and a logical volume VOL having a volume number of “5:0A”. Among the above, the logical volume VOL having a volume number of “1:01” is set as the copy source, and the logical volume VOL having a volume number of “5:0A” is set as the copy destination.

The access management table 46 is a table for managing the availability of data I/O to and from the respective logical volumes VOL existing in the storage system 1, and, as shown in FIG. 5, is configured from a “volume number” field 131, a “data readability setting (R)” field 132, and a “data writability setting (W)” field 133.

The “volume number” field 131 stores the volume number of the corresponding logical volume VOL.

The “data readability setting (R)” field 132 stores information (a flag for example) representing whether there is any setting prohibiting the reading of data from the corresponding logical volume VOL. Specifically, information representing “protected” is stored in the “data readability setting (R)” field 132 when there is a setting prohibiting the reading of data from such logical volume VOL, and information representing “permitted” is stored therein when there is no such setting.

The “data writability setting (W)” field 133 stores information (a flag for example) representing whether there is any setting prohibiting the writing of data in the corresponding logical volume VOL. Specifically, information representing “protected” is stored in the “data writability setting (W)” field 133 when there is a setting prohibiting the writing of data in such logical volume VOL, and information representing “permitted” is stored therein when there is no such setting.

Accordingly, in the example shown in FIG. 5, for instance, although the reading of data is prohibited from the logical volume VOL having a volume number of “1:01”, the writing of data therein is not prohibited. Further, both the reading of data from and the writing of data in the logical volume VOL having a volume number of “5:0A” are prohibited.

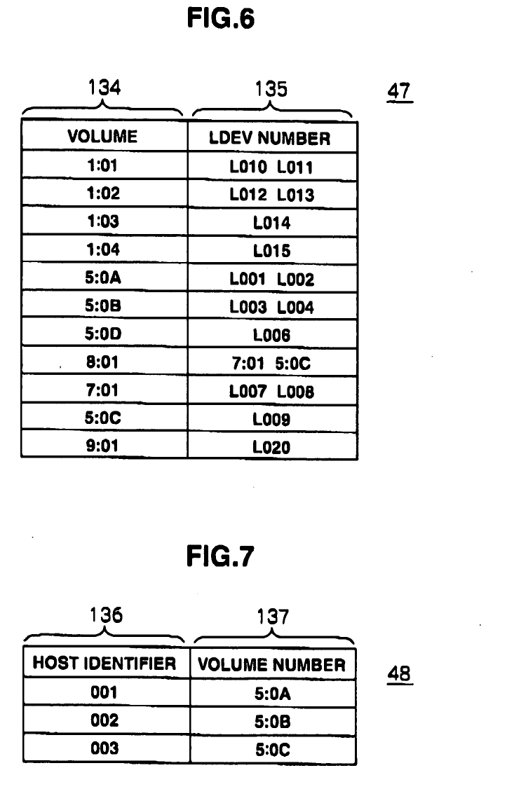

The device management table 47 is a table for the storage apparatus 3 to manage which logical volume VOL set in one's own storage apparatus 3 is configured from which logical device 53, and, as shown in FIG. 6, is configured from a “volume” field 134 and a “LDEV number” field 135.

The “volume” field 134 stores the volume number given to the corresponding logical volume VOL. The “LDEV number” field 135 stores the LDEV number as the identification number of the respective logical devices (LDEV) 53 configuring the logical volumes VOL.

For instance, with the example shown in FIG. 6, the logical volume VOL having a volume number of “1:01” is configured from two logical devices 53 respectively having the LDEV number of “L010” or “L011”. The logical volume VOL having a volume number of “1:03” is configured from one logical device 53 having the LDEV number of “L014”.

The volume host management table 48 is a table for the storage apparatus 3 to manage which host system 2 is accessible to the logical volume VOL in one's own storage apparatus, and, as shown in FIG. 7, is configured from a “host identifier” field 136 and a “volume number” field 137.

The “host identifier” field 136 stores the host ID (host identifier) given to the corresponding host system 2. The “volume number” field 137 stores the volume number of the logical volume VOL that is accessible from the host system 2.

Accordingly, in the example shown in FIG. 7, the host system 2 having a host ID of “001” is able to access the logical volume VOL having a volume number of “5:0A”.

Meanwhile, the memory 21 of the management server 4 stores various control programs such as the access monitoring program 22, the volume change processing program 23, the volume release processing program 24, the copy volume monitoring program 25, the path switching program 26, the performance information collection program 27, the screen display program 2B, the pair type volume creation processing program 33, the non-pair type volume creation processing program 34, and the difference type volume creation processing program 35, as well as various management tables such as the access count management table 29, the hierarchy-based volume management tables 30A and 30B, the setting table 31, and the volume management table 32.

Among the above, the access monitoring program 22 is a program for monitoring the access frequency of the host system 2 to the logical volume VOL in the respective storage apparatuses 3, and functions as an access frequency monitoring unit for monitoring the access frequency of the host system 2 to the logical volume VOL provided by the storage apparatus 2. The CPU 20 of the management server 4 refers to an access count management table 29 described later based on the access monitoring program 22, and monitors the access frequency from the host system 2 to the logical volume VOL in the respective storage apparatuses 3.

In the foregoing case, the CPU 20 determines the volume number of the logical volume VOL, difference volume VOL and base volume VOL (described later) of the copy source/copy destination from a volume management table 32 described later.

Incidentally, the access count to the respective logical volumes VOL managed by the access count management table 29 is counted and collected with existing technology. The volume number and the LDEV number of the respective logical volumes VOL registered in the hierarchy-based volume management tables 30A and 30B shall be defined by the user and set in advance. Similarly, the volume number of the logical volume VOL of the respective copy sources registered in the access management table 46 of the storage apparatus 3 shall also be defined by the user and set in advance.

The volume change processing program 23 is a program for performing creation control processing of the logical volume VOL based on the pair status, and the volume release processing program 24 is a program for performing release processing of the logical volume VOL.

The pair type volume creation processing program 33 is a program for executing pair type volume creation processing, and the non-pair type volume creation processing program 34 is a program for executing non-pair type volume creation processing. The difference type volume creation processing program 35 is a program for executing difference type volume creation processing.

The specific processing contents of the CPU 20 of the management server 4 based on the volume change processing program 23, the volume release processing program 24, the pair type volume creation processing program 33, the non-pair type volume creation processing program 34, and the difference type volume creation processing program 35 will be described later.

The copy volume monitoring program 25 is a program for monitoring the referral frequency of the copy destination logical volume VOL. The CPU 20 of the management server 4 monitors the access frequency of the host system 2 to the logical volume VOL of the copy destination based on the copy volume monitoring program 25 after switching the referral destination of data in a certain logical volume (low-speed logical volume) VOL to another logical volume (high-speed logical volume) VOL based on the referral destination volume switching processing according to this embodiment.

The path switching program 26 is a program for setting or switching the path. The performance information collection program 27 is a program for collecting the performance information of one's own storage apparatus 3 acquired by the respective storage apparatuses 3 based on the foregoing performance collection program 44. The CPU 20 of the management server 4 collects the performance information (including the access count information of the host system 2 to the respective logical volumes VOL) of one's own storage apparatus 3 collected respectively by the respective storage apparatuses 3 from such storage apparatuses 3 using existing methods and based on the performance information collection program 27.

The screen display program 28 is a program for displaying a referral destination volume switching processing setting screen 300 described later. The specific processing contents of the CPU 20 of the management server 4 based on the screen display program 28 will be described later.

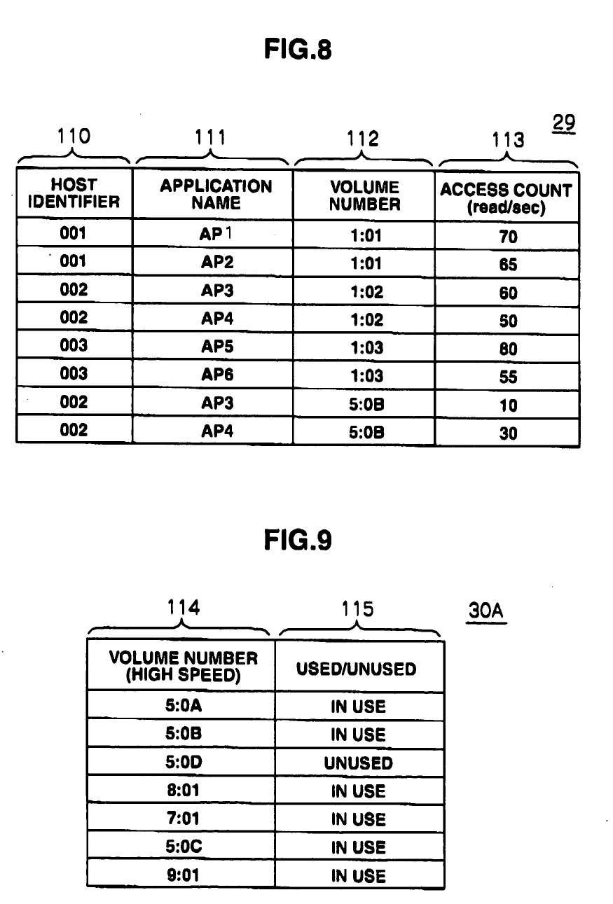

The access count management table 29 is a table to be used for managing the number of times the host system 2 accessed the logical volume VOL via the access path, and, as shown in FIG. 8, is configured from a “host identifier” field 110, an “application name” field 111, a “volume number” field 112, and an “access count” field 113.

Among the above, the “host identifier” field 110 stores the host ID of the corresponding host system 2. The “application name” field 111 stores the application name of the application program loaded in such host system 2.

The “volume number” field 112 stores the volume number of the logical volume VOL accessed by the corresponding application program, and the “access count” field 113 stores the average number of times such application program accessed the logical volume VOL per second.

For example, with the example shown in FIG. 8, the application program having an application name of “AP1” loaded on the host system 2 having a host ID of “001” is accessing the logical volume VOL having a volume number of “1:01” at a frequency of “70” times per second.

The hierarchy-based volume management tables 30A and 30B are tables showing the usage state of the logical volume VOL set in the storage apparatus 3, and are separately provided for use in a high-speed logical volume VOL and use in a low-speed logical volume VOL.

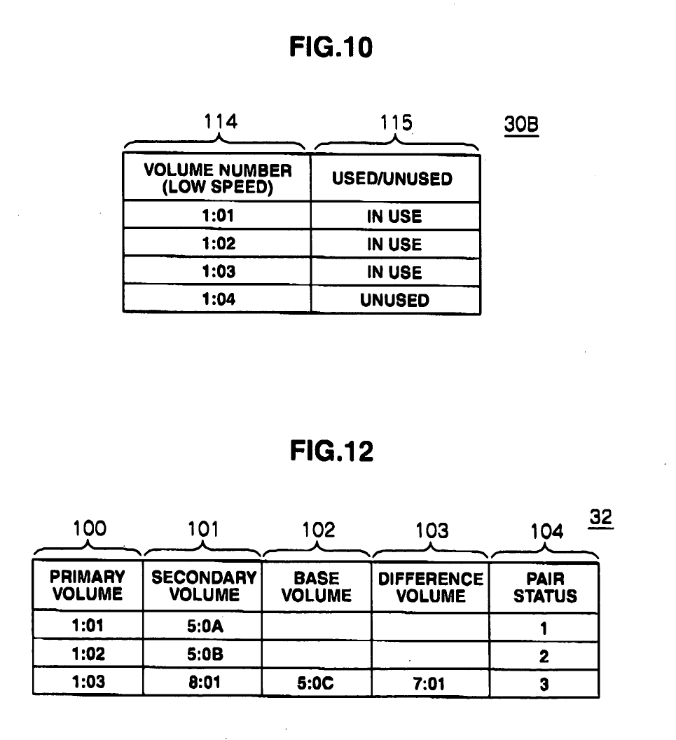

As shown in FIG. 9, the hierarchy-based volume management table for use in a high-speed logical volume VOL (this is hereinafter referred to as a “high-speed hierarchy-based volume management table”) 30A is configured from a “volume number” field 114 and a “used/unused” field 115. Further, as shown in FIG. 10, a hierarchy-based volume management table for use in a low-speed logical volume VOL (this is hereinafter referred to as a “low-speed hierarchy-based volume management table”) 30B is also configured from a “volume number” field 114 and a “used/unused” field 115.

With the high-speed hierarchy-based volume management table 30A, the volume numbers of the respective high-speed logical volumes VOL managed by the high-speed hierarchy-based volume management table 30A are stored in the “volume number” field 114. Similarly, with the low-speed hierarchy-based volume management table 30B also, the volume numbers of the respective low-speed logical volumes VOL managed by the low-speed hierarchy-based volume management table 30A are stored in the “volume number” field 114.

Further, with both the high-speed hierarchy-based volume management table 30A and the low-speed hierarchy-based volume management table 30B, information representing the status of whether the corresponding logical volume VOL is being used is stored in the “used/unused” field 115. Specifically, information (a flag for example) representing “in use” is stored in the “used/unused” field 115 when the logical volume VOL is being used, and information representing “unused” is stored therein when such logical volume VOL is not being used.

Accordingly, with the example shown in FIG. 9, for instance, the high-speed logical volume VOL having a volume number of “5:0A” is being used, but the high-speed logical volume VOL having a volume number of “5:0D” is not being used. Further, with the example shown in FIG. 10, for instance, the low-speed logical volume VOL having a volume number of “1:01” is being used, but the low-speed logical volume VOL having a volume number of “1:04” is not being used.

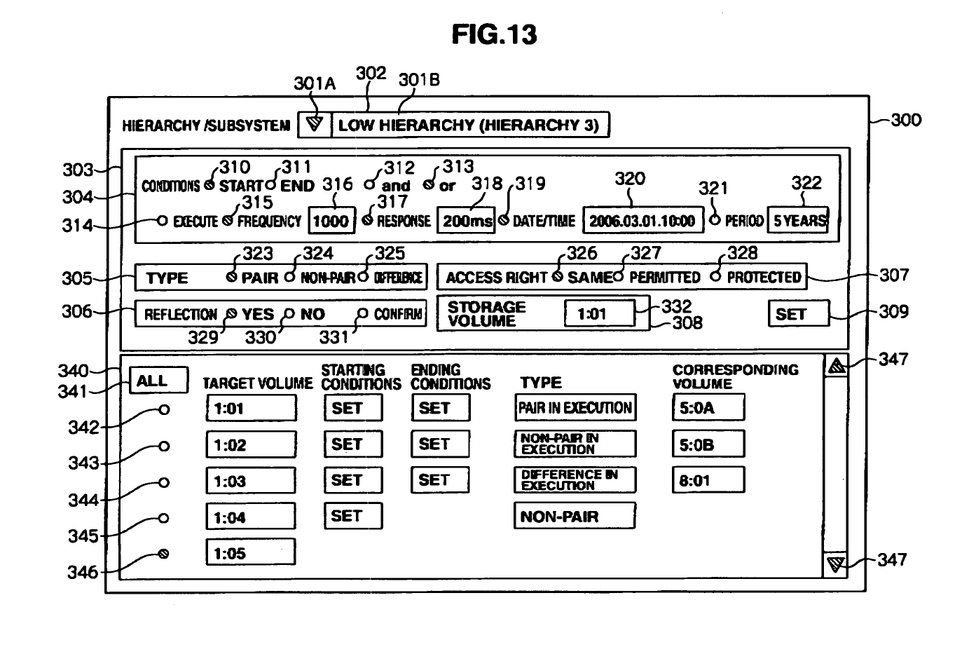

The setting table 31 is a table for managing the start or end of the referral destination volume switching processing set by the system administrator using a referral destination volume switching processing setting/status display screen 300 described later with reference to FIG. 13 with respect to the desired logical volume VOL (primarily a low-speed logical volume VOL).

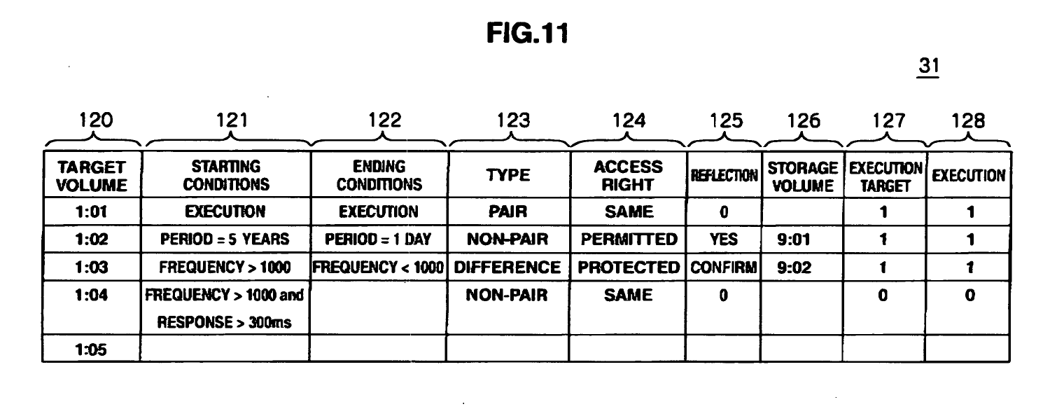

The setting table 31, as shown in FIG. 11, is configured from a “target volume” field 120, a “starting condition” field 121, an “ending condition” field 122, a “type” field 123, an “access right” field 124, a “reflection” field 125, a “storage volume” field 126, an “execution target” field 127, and an “execution” field 128.

Among the above, the “target volume” field 120 stores the volume number of the logical volume VOL selected by the system administrator as the target of referral destination volume switching processing. The “starting condition” field 121 stores the condition (this is hereinafter referred to as “starting condition”) for starting the referral destination volume switching processing set by the system administrator regarding the logical volume VOL. The “ending condition” field 122 stores the condition (this is hereinafter referred to as “ending condition”) for ending the referral destination volume switching processing set by the system administrator regarding the logical volume VOL. The specific contents of such starting condition and ending condition of the referral destination volume switching processing will be described later.

The “type” field 123 stores the pair status (pair, non-pair or difference pair) of the copy pair set to the copy pair formed from a logical volume VOL (primarily a low-speed logical volume VOL) of the copy source and a logical volume VOL (primarily a high-speed logical volume VOL) to become a temporarily copy destination of data in the logical volume regarding the referral destination volume switching processing.

The “access right” field 124 stores the access right set by the system administrator to the logical volume VOL of the copy destination. As this access right, there are three access rights; namely, “same” which sets the write access to the logical volume VOL of the copy destination to be the same access right as the access right set regarding the logical volume VOL of the copy source, “permitted” which permits the write access, and “protected” which prohibits the write access, and the access right set by the system administrator among these three access rights is stored in the “access right” field 124.

The “reflection” field 125 stores setting information regarding whether to reflect the update of data when it was stored in the logical volume VOL of the copy destination upon returning the data copied to the logical volume VOL of the copy destination to the logical volume VOL of the copy source.

As this setting information, there are three types of setting information; namely, “YES” for reflecting the update of data when it was stored in the logical volume VOL of the copy destination in the case of a non-pair status or difference mode, “0” for not reflecting the update of data when it was stored in the logical volume VOL of the copy destination in the case of a non-pair status or difference mode, and “confirm” of displaying the “reflection status” on the referral destination volume switching processing setting/execution screen 300 described later at the release of the non-pair in the case of a non-pair status and waiting for the system administrator to make a selection, and the setting information set by the system administrator among the foregoing three types of setting information is stored in the “reflection” field 125.

The “storage volume” field 126 stores the volume number of a logical volume (this is hereinafter referred to as “storage volume”) VOL of the storage destination for storing the difference between the data contents in the logical volume VOL of the copy destination and the data contents of the logical volume VOL of the copy source when there is a setting for returning the data to the logical volume VOL of the copy source in a state of reflecting the updated contents of the data when it was stored in the logical volume VOL of the copy destination as described above.

The “execution target” field 127 stores a flag (this is hereinafter referred to as “execution target flag”) representing whether the starting condition or the ending condition of the foregoing referral destination volume switching processing set by the system administrator regarding the logical volume VOL of the copy source has been satisfied. Specifically, in the initial state, “0” is stored in the “execution target” field 127, and “1” is thereafter stored in the “execution target” field 127 when either the starting condition or the ending condition is satisfied.

The “execution” field 128 stores a flag representing whether the referral destination volume switching processing is in an execution state regarding the logical volume VOL of the copy source. Specifically, “0” is stored in the “execution” field 128 when the referral destination volume switching processing is not in an execution state and “1” is stored in the “execution” field 128 when the referral destination volume switching processing is in an execution state.

The volume management table 32 is a table used for managing the logical volume VOL of the respective storage apparatuses 3, and, as shown in FIG. 12, is configured from a “primary volume” field 100, a “secondary volume” field 101, a “base volume” field 102, a “difference volume” field 103, and a “pair status” field 104.

The “primary volume” field 100 stores the volume number of the logical volume VOL of the copy source during the foregoing referral destination volume switching processing. The “secondary volume” field 101 stores the volume number of the logical volume VOL of the copy destination during the referral destination volume switching processing.

When the logical volume VOL of the copy destination is a virtual logical volume (this is hereinafter referred to as “virtual volume”) VOL based on the foregoing referral destination volume switching processing, the “base volume” field 102 stores the volume number of a logical volume (this is hereinafter referred to as “base volume”) VOL to which data stored in a low-speed logical volume VOL was copied among the logical volumes VOL configuring such virtual volume VOL.

The “difference volume” field 103 stores the volume number of a logical volume (this is hereinafter referred to as “difference volume”) VOL storing data of the changed portion when another logical volume VOL configuring the foregoing virtual volume VOL; that is, when there is change after completely copying data from the low-speed logical volume VOL to the high-speed logical volume VOL. The “pair status” field 104 stores the pair status set regarding the logical volume VOL in which the volume number is stored in the “primary volume” field 100.

Accordingly, for instance, with the example shown in FIG. 12, the low-speed logical volume VOL having a volume number of “1:01” and the high-speed logical volume VOL having a volume number of “5:0A” are configured as a pair based on the referral destination volume switching processing, and it is evident that the pair status of the low-speed logical volume VOL and the high-speed logical volume VOL is a pair type.

Incidentally, with respect to the low-speed logical volume VOL having a volume number of “1:03” and the high-speed logical volume VOL having a volume number of “8:01”, although the low-speed logical volume and the high-speed logical volume are pair-configured in a pair status of a difference type, the high-speed logical volume VOL is configured from a virtual volume VOL having a volume number of “8:01” configured from a base volume VOL having a volume number of “5:0C” and a difference volume VOL having a volume number of “7:01”.

### (2-2) Details of Referral Destination Volume Switching Function

### (2-2-1) Referral Destination Volume Switching Processing Setting/Execution Screen

With this storage system 1, a screen display program 28 is loaded in the management server 4 as described above, and the referral destination volume switching processing setting/execution screen 300 shown in FIG. 13 can be displayed on the display of the management server 4 by activating the screen display program 28.

The referral destination volume switching processing setting/execution screen 300 is a GUI (Graphical User Interface) screen used for making various settings relating to the referral destination volume switching function or changing such settings, and is configured from a volume hierarchy/storage selection unit 302, a condition setting unit 303, and a processing status display unit 340.

Among the above, the volume hierarchy/storage selection unit 302 is configured from a pulldown menu button 301A and a volume hierarchy/storage display box 301B. On the referral destination volume switching processing setting/execution screen 300, by clicking the pulldown menu button 301A of the volume hierarchy/storage selection unit 302, it is possible to display a pulldown menu listing the names of all hierarchies and the names of all storage apparatuses of the logical volume VOL managed by the management server 4.

Here, a “hierarchy” of the logical volume VOL means the attribute of the logical volume VOL (group to which the logical volume VOL belongs) when the logical volume VOL is separated into a plurality of groups according to its response speed.

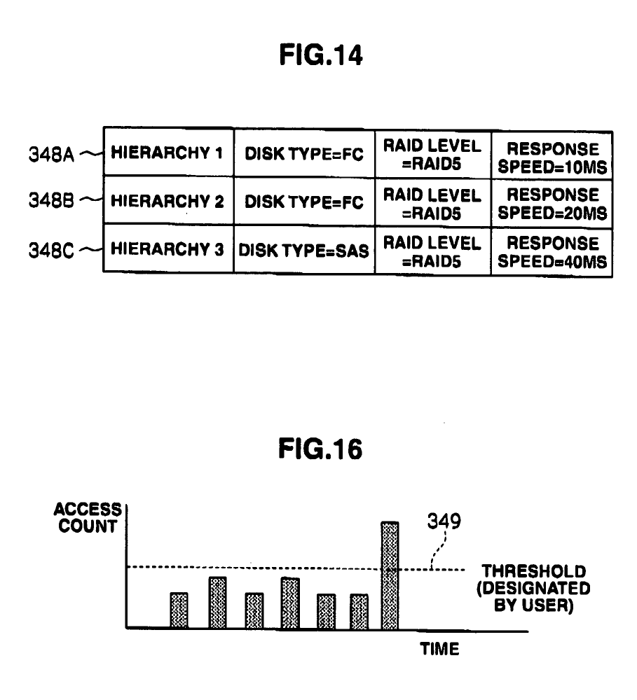

In this embodiment, as shown in FIG. 14, a logical volume VOL set on a storage extent provided by a RAID group having a RAID level of RAID 5 configured from fibre channel disks having a response speed of roughly 10 [ms] is defined as the first hierarchy, a logical volume VOL set on a storage extent provided by a RAID group having a RAID level of RAID 5 configured from fibre channel disks having a response speed of roughly 20 [ms] is defined as the second hierarchy, and a logical volume VOL set on a storage extent provided by a RAID group having a RAID level of RAID 5 configured from SATA disks having a response speed of roughly 40[ms] is defined as the third hierarchy.

In this embodiment, the logical volume VOL of the first and second hierarchies is defined as a high-speed logical volume VOL, and the logical volume VOL of the third hierarchy is defined as a low-speed logical volume VOL.

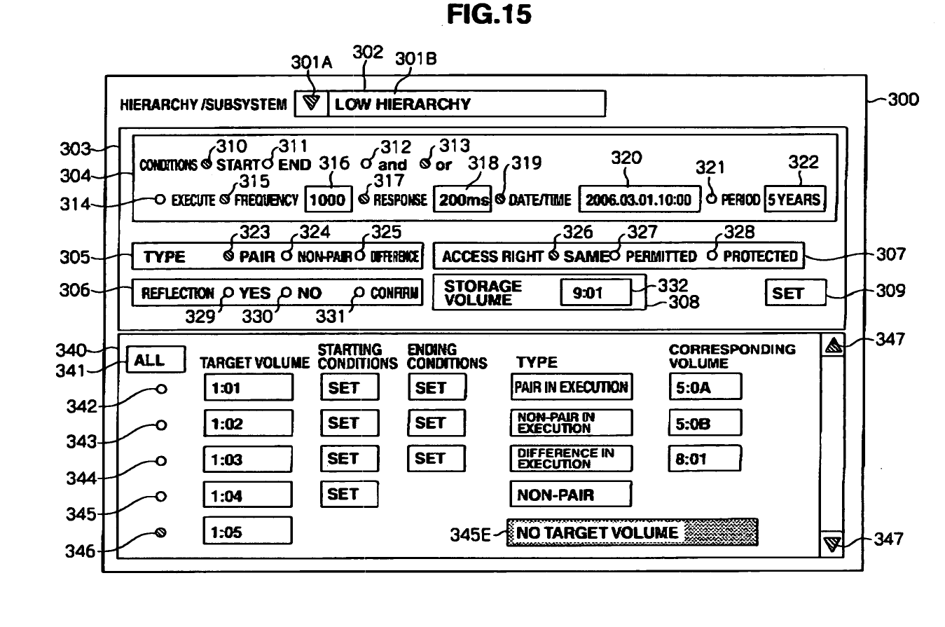

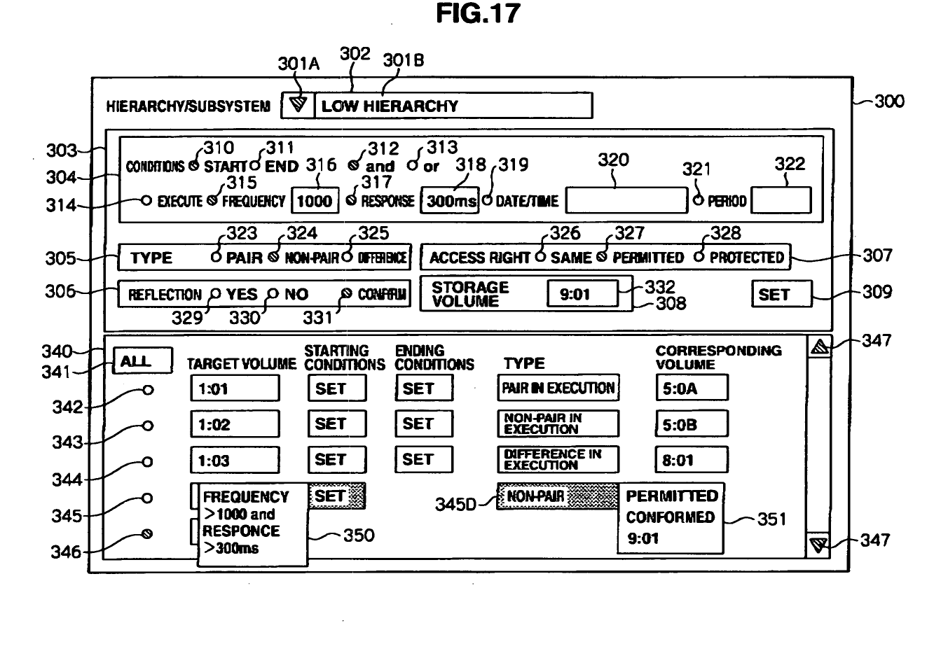

The system administrator is able to select one desired hierarchy name or storage apparatus name by operating a mouse among the hierarchy names and apparatus names of the respective storage apparatuses 3 of the first to third hierarchies listed in the pulldown menu. The logical volume VOL belonging to the hierarchy of the selected hierarchy name or the storage apparatus 3 of the selected storage apparatus name is displayed in the status display unit 340 of the referral destination volume switching processing setting/execution screen 300 as the logical volume VOL to become the copy source during the referral destination volume switching processing. Incidentally, when there is no corresponding logical volume VOL at such time, as shown in FIG. 15, a warning 345E such as “no target volume” is displayed.

The condition setting unit 303 is configured from a condition setting column 304, a pair status setting column 305, an access right setting column 307, a reflection status setting column 306, a storage volume setting column 308, and an enter button 309.

Among the above, a start button 310 and an end button 311 are provided at the upper left side of the condition setting column 304, and either the start button 310 or the end button 311 can be alternatively selected. By selecting the start button 310 on the referral destination volume switching processing setting/execution screen 300, the various items set using the condition setting column 304 can be made to be the starting condition of the foregoing referral destination volume switching processing, and, by selecting the end button 311, the various items can be made to be the ending condition of the referral destination volume switching processing. For instance, with the example shown in FIG. 13, since the start button 310 is selected among the start button 310 and the end button 311, the condition displayed on the referral destination volume switching processing setting/execution screen 300 at such time will be the starting condition.

Further, an AND button 312 and an OR button 313 are provided to the right side of the end button 311 in the condition setting column 304, and either the AND button 312 or the OR button 313 can be alternatively selected. By selecting the AND button 312 on the referral destination volume switching processing setting/execution screen 300, the satisfaction of all conditions relating to the “access frequency”, “response speed”, “date/time” and “period” described later that are set with the condition setting column 304 can be made to be the starting condition or the ending condition of the foregoing referral destination volume switching processing. By selecting the OR button 313, the satisfaction of one condition among the “access frequency”, “response speed”, “date/time” and “period” can be made to be the starting condition or the ending condition of the foregoing referral destination volume switching processing.

With the example shown in FIG. 13, since the OR button 313 is selected among the AND button 312 and the OR button 313, the satisfaction of one condition among the respective conditions relating to “access frequency”, “response speed”, “date/time” and “period” displayed on the referral destination volume switching processing setting/execution screen 300 is the starting condition of the referral destination volume switching processing.

Further, an execution button 314 is provided at the lower side of the start button 310 and the end button 311 in the condition setting column 304. The execution button 314 is a button for making the corresponding storage apparatus 3 immediately execute the referral destination volume switching processing to the logical volume VOL selected in the processing status display unit 340 regardless of the respective conditions of “access frequency”, “response speed”, “date/time” and “period” designated by the system administrator using the condition setting column 304. By clicking the enter button 309 provided at the lower right of the condition setting column 304 after selecting the execution button 314 on the referral destination volume switching processing setting/execution screen 300, it is possible to make the corresponding storage apparatus 3 execute the referral destination volume switching processing.

Further, a frequency button 315 is provided to the right side of the execution button 314 in the condition setting column 304. The frequency button 315, as shown in FIG. 16, is a button for including the “access frequency” (access count) per unit time (for examples one second) of the host system 2 to the target logical volume VOL as the starting condition or the ending condition of the foregoing referral destination volume switching processing. By selecting the frequency button 315 and then inputting the desired access frequency in the frequency setting column 316 provided to the right side of the frequency button 315 on the referral destination volume switching processing setting/execution screen 300, the access frequency can be included as the starting condition or the ending condition of the foregoing referral destination volume switching processing. For instance, with the example shown in FIG. 13, the referral destination volume switching processing is designated to start when the access frequency becomes “1000” or more times.

Meanwhile, a pair type button 323, a non-pair type button 324, and a difference type button 325 are provided to the pair status setting column 305 respectively in correspondence to the pair type, non-pair type and difference type as the pair status of the copy pair during the referral destination volume switching processing. In the pair status setting column 305, one among the pair type button 323, the non-pair type button 324, and the difference type button 325 can be alternatively selected. By selecting one among the pair type selection button 323, the non-pair type selection button 324, and the difference type selection button 325 on the referral destination volume switching processing setting/execution screen 300, it is possible to designate the pair status corresponding to the selected button as the pair status of the copy pair upon executing the referral destination volume switching processing.

A same button 326, a permitted button 327, and a protected button 328 are provided to the access right setting column 307 respectively in correspondence to the options of “same”, “permitted”, and “protected” upon setting the availability of writing in the logical volume VOL of the copy destination. In the access right setting unit, one among the same button 326, the permitted button 327, and the protected button 328 can be alternatively selected. By selecting the same button 326 on the referral destination volume switching processing setting/execution screen 300, it is possible to command that the access right that is the same as the status setting set in the logical volume VOL of the copy source should also be set in the logical volume VOL of the copy destination. By selecting the permitted button 327 on the referral destination volume switching processing setting/execution screen 300, it is possible to designate a setting of permitting the writing in the logical volume VOL of the copy destination, and by selecting the protected button 328, it is possible to designate a setting of prohibiting the writing in the logical volume VOL.

A YES button 329, a NO button 330, and a confirm button 331 are provided to the reflection status setting column 306 as buttons for designating whether to reflect the update of data in the logical volume VOL of the copy destination to the data in the logical volume VOL of the copy source when a non-pair type or a difference type is selected as the pair status of the copy pair during the referral destination volume switching processing. With the reflection status setting column 306, one among the YES button 329, the NO button 330, and the confirm button 331 can be alternatively selected.

By selecting the YES button 329 on the referral destination volume switching processing setting/execution screen 300, it is possible to reflect the update of data in the logical volume VOL of the copy destination to the data in the logical volume VOL of the copy source when a non-pair type or a difference type is selected as the pair status of the copy pair during the referral destination volume switching processing. In addition, by selecting the NO button 330, it is possible to not reflect the update of data in the logical volume VOL of the copy destination to the data in the logical volume VOL of the copy source. Further, by selecting the confirm button 331 on the referral destination volume switching processing setting/execution screen 300, it is possible to display a confirmation screen upon performing such reflection.

A storage volume input column 332 is provided to the storage volume setting column 308 for designating a storage volume VOL storing the difference between the data stored in the logical volume VOL of the copy destination and the date stored in the logical volume VOL of the copy source when a non-pair type or a difference type is selected as the pair status of the copy pair during the referral destination volume switching processing, and the update of data in the logical volume VOL of the copy destination is to be reflected in the data in the logical volume VOL of the copy source. By inputting a desired volume number in the storage volume input column 332 on the referral destination volume switching processing setting/execution screen 300, it is possible to designate the logical volume VOL described in the storage volume input column 332 as the storage volume VOL. For instance, with the example shown in FIG. 13, the logical volume VOL having a volume number of “1:01” is designated as the storage volume VOL.

An enter button 309 is provided to the right side of the storage volume setting column 308. The enter button 309 is a button for setting the condition of the respective items such as “access frequency” and “response speed” designated in the condition setting unit 303. By clicking the enter button 309 after designating the various conditions using the condition setting unit 303 on the referral destination volume switching processing setting/execution screen 300, it is possible to incorporate and set the contents of such various conditions in the management server 4.

Meanwhile, the volume numbers of the logical volume VOL belonging to the hierarchy of the logical volume VOL selected by the system administrator using the volume hierarchy/storage selection unit 302 and the logical volume VOL set in the storage apparatus 3 selected by the system administrator using the volume hierarchy/storage selection unit 302 are displayed as a list at a prescribed volume number display position 342 (position in the row where the text “Target Volume” is displayed in FIG. 13) on the status display unit 340. Selection buttons 342 to 346 are respectively displayed on the left side of the volume numbers of the respective logical volumes VOL displayed as a list on the status display unit 340.

By selecting one selection button 342 to 346 corresponding to the desired logical volume among the selection buttons 342 to 346 displayed on the referral destination volume switching processing setting/execution screen 300, it is possible to select the logical volume VOL to become applicable to the starting condition or the ending condition set in the foregoing condition setting unit 303. For instance, with the example shown in FIG. 13, the selection button 346 is selected among the selection buttons, and the logical volume VOL having a volume number of “1:05” is selected as the applicable target.

Incidentally, by clicking the “ALL” button 341 displayed at the upper left side of the status display unit 340 on the referral destination volume switching processing setting/execution screen 300, it is possible to select all logical volumes VOL in which the volume number is displayed on the status display unit 340 at such time as the logical volume VOL of the applicable target.

In the status display unit 340, when the starting condition and the ending condition during the referral destination volume switching processing are set in relation to the logical volume VOL for each logical volume VOL in which a volume number is displayed, the text “Set” is displayed at a prescribed first setting status display position 343 (position of the row where the text “Staring Condition” is displayed in FIG. 13), and a prescribed second setting status display position (position of the row where the text “Ending Condition” are displayed in FIG. 13).

Accordingly, for instance, with the example shown in FIG. 13, although the starting condition and the ending condition are respectively set to each logical volume having a volume number of “1:01” to “1:03”, only the starting condition is set to the logical volume having a volume number of “1:04”, and neither the starting condition nor the ending condition is set to the logical volume having a volume number of “1:05”.

By clicking the text “Set” displayed in the status display unit 340, for instance, as shown in FIG. 17, it is possible to display the contents of the starting condition or the ending condition set to the corresponding logical volume VOL in a pulldown format in the status display unit 340.

Further, the pair status of the copy pair during the referral destination volume switching processing set in relation to the logical volume VOL for each logical volume VOL, in which the volume number is displayed, is displayed on a prescribed type display position (position of the row displaying the text “Type” in FIG. 13) in the status display unit 340, and, when the referral destination volume switching processing is being executed regarding the logical volume VOL at such time, the text “In Execution” are displayed after the pair status displayed at the type display position.

For instance, with the example shown in FIG. 13, “pair type” is set as the pair status of the copy pair during the referral destination volume switching processing regarding the logical volume VOL having a volume number of “1:01”, and shows that the referral destination volume switching processing is currently being executed regarding such logical volume VOL. Further, “non-pair type” is set as the pair status of the copy pair during the referral destination volume switching processing regarding the logical volume VOL having a volume number of “1:04”, and shows that the referral destination volume switching processing is not currently being executed regarding such logical volume VOL.

By clicking the text (“Pair in Execution” or “Non-pair in Execution”) displayed in the status display unit 340, as shown in FIG. 17, it is possible to display the setting contents relating to the “access right”, “reflection” and “storage volume” set regarding the corresponding logical volume VOL in a pulldown format on the status display unit 340.

Further, the volume number of the logical volume VOL pair-configured with the logical volume VOL for each logical volume VOL set with a copy pair during the referral destination volume switching processing among the logical volumes VOL, in which the volume number is displayed, is displayed at a prescribed corresponding volume display position (position of the row displaying the text “Corresponding Volume” in FIG. 13) on the status display unit 340.

For instance, with the example shown in FIG. 13, the logical volume VOL having a volume number of “5:0A” is set as the pair during the referral destination volume switching processing regarding the logical volume VOL having a volume number of “1:01”.

### (2-2-2) Referral Destination Volume Switching Processing when Pair Status is Pair Type

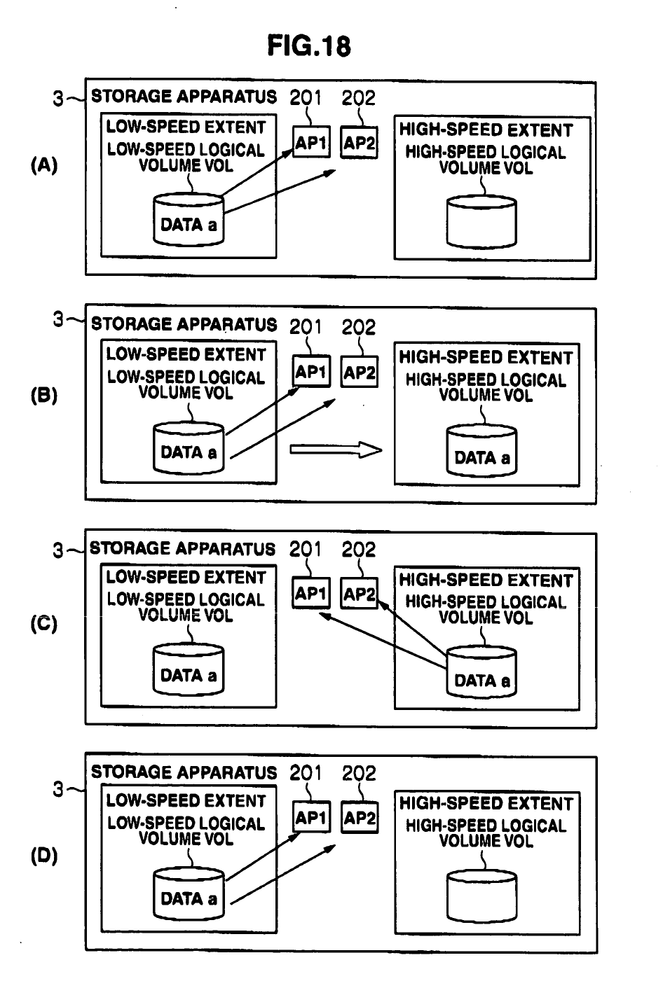

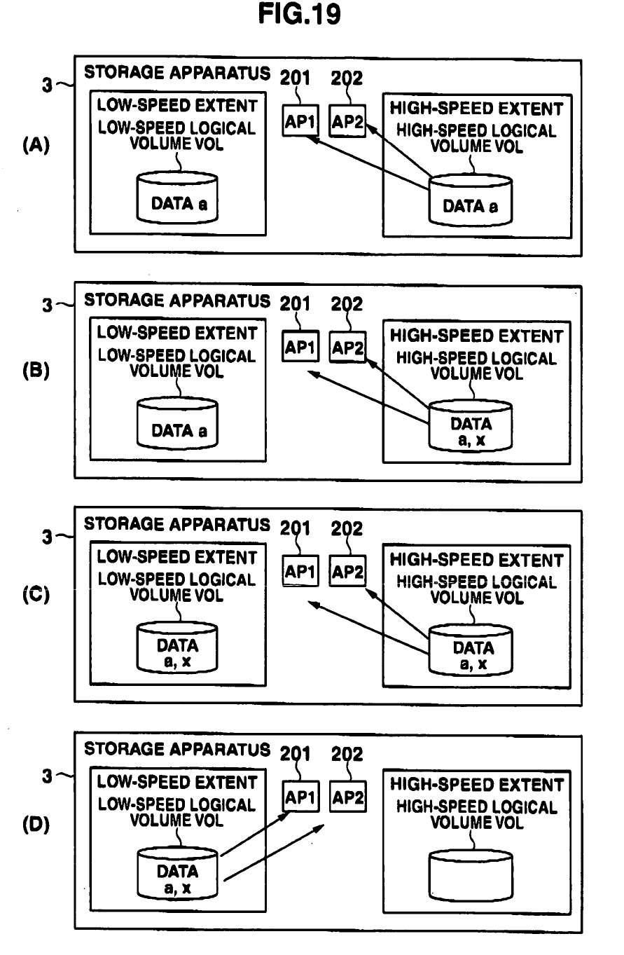

The specific flow of referral destination volume switching processing in the storage system 1 is now explained with reference to FIG. 18 to FIG. 23 for each pair status. Foremost, referral destination volume switching processing for switching the referral destination of the logical volume VOL set with a pair type as the pair status to another logical volume is explained.

As shown in FIG. 18A, data with a low access frequency is stored in a low-speed logical volume VOL. The management server 4 monitors the access frequency of the respective application programs 201 and 202 of the host computer 2 to the low-speed logical volume VOL with respect to the frequency of accessing data in the low-speed logical volume VOL based on the access count management table 29.

When the access frequency from the application programs 201 and 202 to the low-speed logical volume VOL becomes high, as shown in FIG. 18B, the management server 4 controls the corresponding storage apparatus 3 so as to copy the data (“data a”) stored in a low-speed logical volume VOL to a high-speed logical volume VOL. The management server 4 thereafter uses the device management table 47 and switches the setting of the volume number of the low-speed logical volume VOL and the high-speed logical volume VOL. Thereby, the host system 2 will be able to access the high-speed logical volume VOL without having to change the device name recognized by the application program.

Thereafter, when a data write request is issued from the application programs 201 and 202 to the host system 2 for writing data in the low-speed logical volume VOL, the corresponding storage apparatus 3 writes such data in both the low-speed logical volume VOL and the high-speed logical volume VOL. When a read access request of data stored in the low-speed logical volume VOL and the high-speed logical volume VOL is given from the application programs 201 and 202 of the host system 2, the storage apparatus 3 reads such data from the high-speed logical volume VOL and sends it to the host system 2.

Here, as shown in FIG. 18C, the management server 4 monitors the access frequency of the application programs 201 and 202 stored in the host system 2 to the high-speed logical volume VOL based on the access count management table 29. When the access frequency to the high-speed logical volume VOL becomes low, as shown in FIG. 18D, the management server 4 uses the device management table 47 to switch the volume number of the low-speed logical volume VOL and the high-speed logical volume VOL. As a result, the input and output of data will be performed to and from the low-speed logical volume VOL based on the read access request or write access request from the application programs 201 and 202 of the host system 2. The management server 4 thereafter deletes the data (“data a”) stored in the high-speed logical volume VOL from the high-speed logical volume VOL, and thereby releases the high-speed logical volume VOL.

### (2-2-3) Referral Destination Volume Switching Processing when Pair Status is Non-Pair Type

Referral destination volume switching processing for switching the referral destination of the logical volume VOL set with a non-pair type as the pair status to another logical volume is now explained.

As shown in FIG. 19A, data with a low access frequency is stored in a low-speed logical volume VOL. The management server 4 monitors the access frequency of the respective application programs 201 and 202 of the host computer 2 to the low-speed logical volume VOL with respect to the frequency of accessing data in the low-speed logical volume VOL based on the access count management table 29.

When the access frequency from the application programs 201 and 202 to the low-speed logical volume VOL becomes high, as shown in FIG. 19B, the management server 4 controls the corresponding storage apparatus 3 so as to copy the data (“data a”) stored in a low-speed logical volume VOL to a high-speed logical volume VOL.

The management server 4 thereafter refers to the path connection information table 14 and switches the path set from the host system 2 to the low-speed logical volume VOL to a path set from the host system 2 to the high-speed logical volume VOL, and further switches the volume number of the low-speed logical volume VOL and the high-speed logical volume VOL of the volume management table 32.

Thereafter, when there is a write access request from the application programs 201 and 202 of the host system 2 to the low-speed logical volume VOL, the corresponding storage apparatus 3 writes such data in the high-speed logical volume VOL. When a read access request of data stored in the high-speed logical volume VOL is given from the application programs 201 and 202 of the host system 2, the storage apparatus 3 reads such data from the high-speed logical volume VOL and sends it to the host system 2.

Here, as shown in FIG. 19C, the management server 4 monitors the access frequency of the application programs 201 and 202 stored in the host system 2 to the high-speed logical volume VOL based on the access count management table 29. When the referral frequency to the high-speed logical volume VOL becomes low, the management server 4 inquires the system administrator (user) to confirm whether to leave the high-speed logical volume VOL.

When a command for leaving the high-speed logical volume VOL is given from the system administrator, the management server 4 leaves the high-speed logical volume VOL as is and does not change the path. Contrarily, when a command for not leaving the high-speed logical volume VOL is given from the system administrator, the management server 4 inquires the system administrator to confirm whether to reflect the updated data stored in the high-speed logical volume VOL.

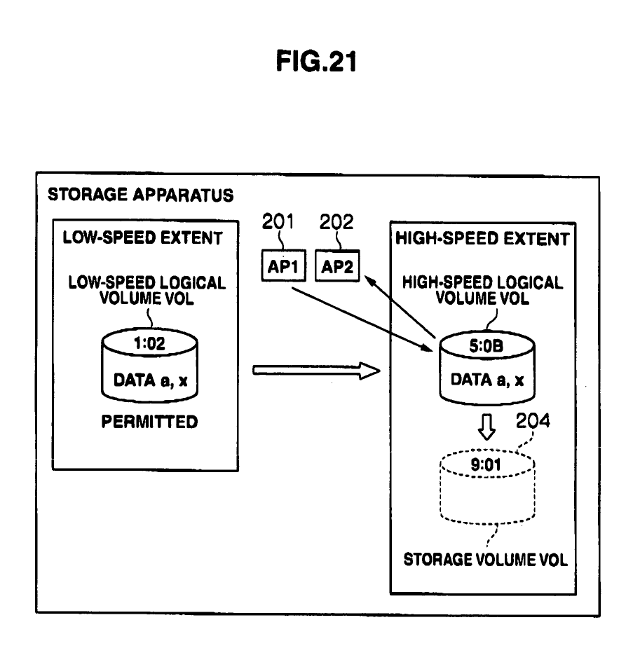

When a command for reflecting the updated data is given from the system administrator, the management server 4 controls the corresponding storage apparatus 3 so as to copy the data stored in the high-speed logical volume VOL to a low-speed logical volume VOL or the storage volume VOL shown in FIG. 21.

In addition, as shown in FIG. 19D, the management server 4 uses the path connection information table 14 and changes the access path set from the host system 2 to the high-speed logical volume VOL to a path from the host system 2 to the low-speed logical volume VOL, and further changes the volume number of the high-speed logical volume VOL and the low-speed logical volume VOL of the volume management table 32.

Even when a command for not reflecting the updated data is given, the management server 4 similarly changes the access path, and changes the volume number of the high-speed logical volume VOL and the low-speed logical volume VOL of the volume management table 32.

As a result, the input and output of data will be performed to and from the low-speed logical volume VOL based on the read access request or write access request from the application programs 201 and 202 of the host system 2. The management server 4 thereafter deletes the data (“data a”; “data a and x” when the data is changed) stored in the high-speed logical volume VOL from the high-speed logical volume VOL, and thereby releases the high-speed logical volume VOL.

### (2-2-4) Referral Destination Volume Switching Processing when Pair Status is Difference Type

Referral destination volume switching processing for switching the referral destination of the logical volume VOL set with a difference type as the pair status to another logical volume is now explained.

The management server 4 monitors the access frequency of the respective application programs 201 and 202 of the host computer 2 to the low-speed logical volume VOL with respect to the frequency of accessing data in the low-speed logical volume VOL based on the access count management table 29.

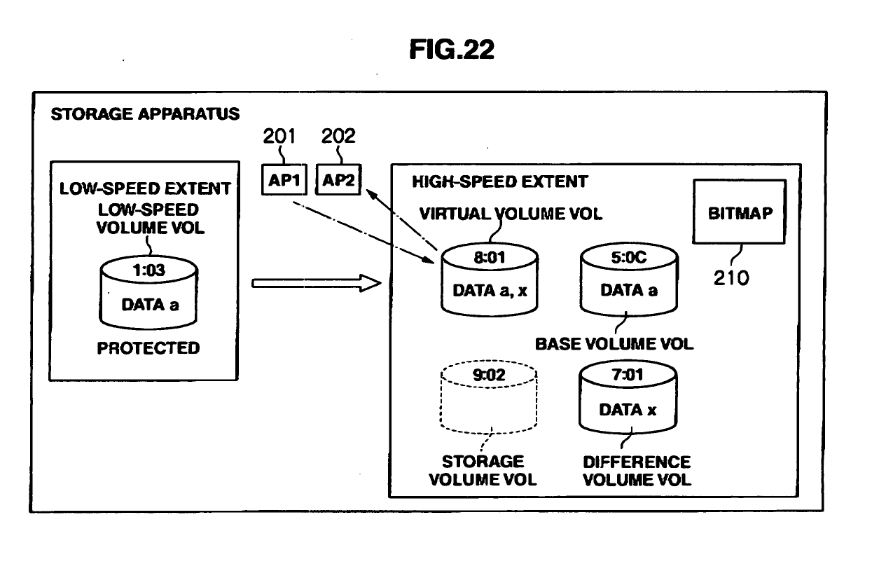

When the access frequency from the application programs 201 and 202 to the low-speed logical volume VOL becomes high, the management server 4 sets a virtual volume VOL as the high-speed logical volume VOL. The virtual volume VOL, as shown in FIG. 22, is actually configured from a base volume VOL and a difference volume VOL, and the block address of the logical blocks of the base volume VOL and the difference volume VOL is stored in the virtual volume VOL.

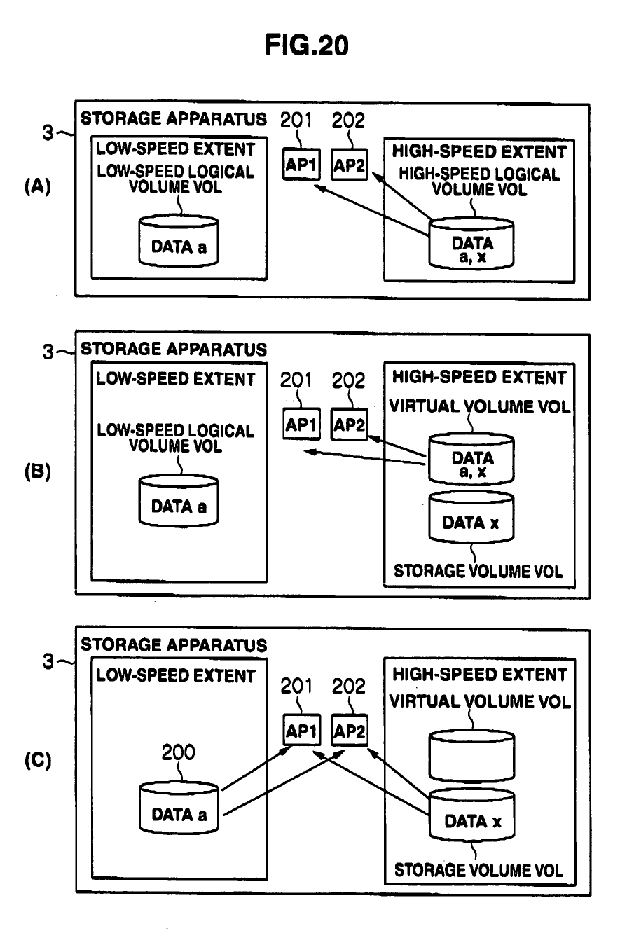

The management server 4 controls the corresponding storage apparatus 3 so as to copy the data (“data a”) stored in a low-speed logical volume VOL to the base volume VOL as the high-speed logical volume VOL. The management server 4 thereafter uses the path connection information table 14, and, as shown in FIG. 20A, changes the path set from the host system 2 to the low-speed logical volume VOL to a path set from the host system 2 to the virtual volume VOL.

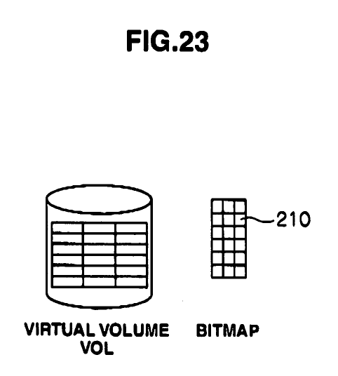

Thereafter, when there is a write access request from the application programs 201 and 202 of the host system 2 to the low-speed logical volume VOL, the corresponding storage apparatus 3, as shown in FIG. 20B, writes data in the difference volume VOL since the virtual volume VOL is subject to write-protect. Since a bitmap 210 is associated with the respective logical blocks of the virtual volume VOL as shown in FIG. 23, when there is a new write request to a certain logical block of a virtual volume VOL, “1” is set in the corresponding portion of the bitmap 210.

When a read access request is given from the application programs 201 and 202 of the host system 2 to the virtual volume VOL, the storage apparatus 3 refers to the bitmap 210 to check whether the corresponding logical block has been changed and, since the data has been changed if the bitmap is “1”, reads the data from the difference volume VOL and sends it to the host system 2. Meanwhile, if the bitmap 210 is “0”, since the data has not been changed, the storage apparatus 3 reads the data from the base volume VOL and sends it to the host system 2.

Here, the management server 4 monitors the access frequency of the application programs 201 and 202 stored in the host system 2 to the virtual volume VOL based on the access count management table 29. When the referral frequency to the virtual volume VOL becomes low, the management server 4 inquires the system administrator (user) to confirm whether to leave the updated data.

When a command for leaving the updated data is given from the system administrator, the management server 4 controls the corresponding storage apparatus 3 so as to store the data of the virtual volume VOL in the storage volume VOL. As shown in FIG. 20C, the management server 4 thereafter uses the path connection information table 14 and changes the access path set from the host system 2 to the virtual volume VOL to a path from the host system 2 to the storage volume VOL, and further changes the volume number of the volume management table 32.

Meanwhile, when a command for reflecting the updated data is not given, the management server 4 uses the path connection information table 14 and changes the path set from the host system 2 to the virtual volume VOL to a path from the host system 2 to the low-speed logical volume VOL, and further changes the volume number of the volume management table 32. As a result, the input and output of data based on the read access request or the write access request from the application programs 201 and 202 of the host system 2 will be performed by the storage volume VOL when a command for leaving the updated data is given from the system administrator.

Meanwhile, when a command for reflecting the updated data is not given, the input and output of data based on the read access request or the write access request from the application programs 201 and 202 of the host system 2 will be performed by the low-speed logical volume VOL. The management server 4 thereafter deletes the data (“data a”; “data a and x” when the data is changed) stored in the base volume VOL and the difference volume VOL from the respective logical volumes VOL, and thereby releases the base volume VOL, the difference volume VOL and the virtual volume VOL.

### (2-2-5) Specific Processing Contents of CPU of Management Server

### (2-2-5-1) Referral Destination Volume Switching Processing

The specific processing contents of the CPU 20 of the management server 4 relating to the referral destination volume switching processing are now explained. In the following example, a case is explained where there are two logical volumes VOL; namely, the low-speed logical volume VOL and the high-speed logical volume VOL in a single storage apparatus.

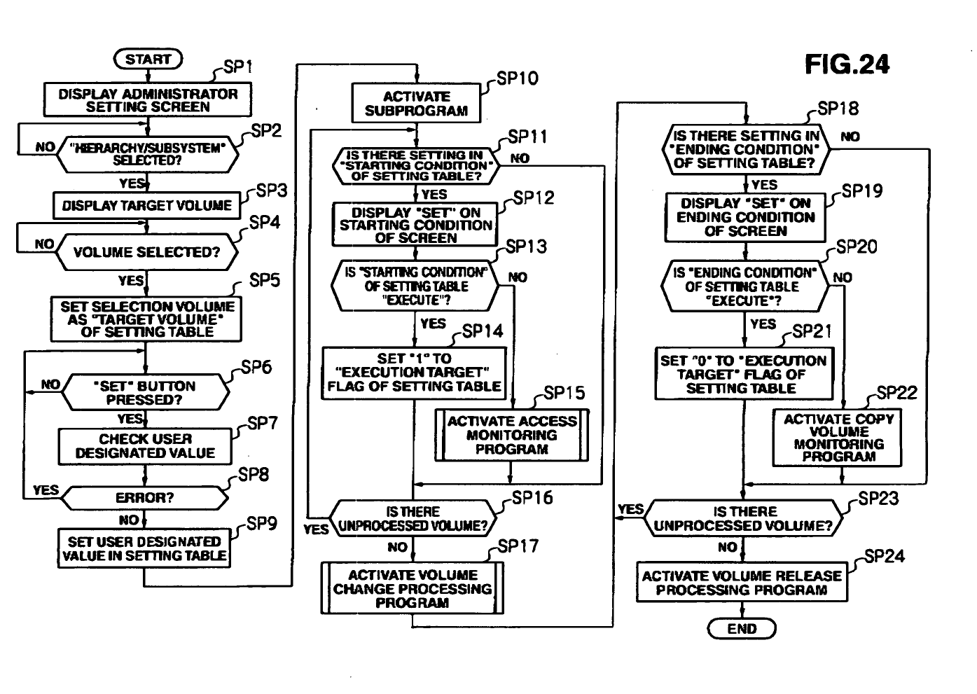

FIG. 24 is a flowchart showing the processing contents of the CPU 20 of the management server 4 relating to the referral destination volume switching processing. When the system administrator operates the management sever 4 and a display command of the referral destination volume switching processing setting/execution screen 300 described with reference to FIG. 13 is input, the CPU 20 starts this referral destination volume switching processing, and foremost displays the referral destination volume switching processing setting/execution screen 300 on the display of the management server 4 based on the screen display program 28 (SP1).

Subsequently, the CPU 20 waits for the system administrator to operate the volume hierarchy/storage selection unit 302 of the referral destination volume switching processing setting/execution screen 300 and select a hierarchy (first to third hierarchies described with reference to FIG. 14) of a logical volume VOL, or a storage apparatus (SP2).

When a hierarchy of a logical volume VOL, or a storage apparatus is eventually selected (SP2: YES), the CPU 20 refers to the volume management table 32, searches all logical volumes belonging to the selected hierarchy or all target logical volumes contained in the selected storage apparatus 3, and displays a list of the volume numbers thereof at a prescribed position on the processing status display unit 340 of the referral destination volume switching processing setting/execution screen 300 (SP4).

The CPU 20 thereafter waits for one logical volume VOL among the respective logical volumes VOL in which the volume numbers are displayed on the processing status display unit 340 of the referral destination volume switching processing setting/execution screen 300 to be selected as the target volume (SP4) and, when the target volume is eventually selected (SP4: YES), sets the selected logical volume VOL as the “target volume” in the setting table 31 provided in the management server 4 (SP5).

The CPU 20 waits for the enter button 309 in the condition setting unit 303 to be clicked (SP6) and, when the enter button 309 is eventually clicked (SP6: YES), checks whether the necessary conditions such as the starting condition, ending condition, type, access right and so on have been designated in the condition setting unit 303 and whether the designated values are appropriate (SP7).

When the CPU 20 detects an error during this check (SP8: YES), it displays a necessary error message on the display of the management server 4, and once again waits for the enter button 309 to be clicked (SP6 to SP8).

Meanwhile, when the CPU 20 does not detect an error in the determination at step SP8 (SP8: NO), it sets the user's designated value in the setting table 31 (SP9), and activates a subprogram (SP10). Thereby, the CPU 20 thereafter updates the referral destination volume switching processing setting/execution screen 300 according to the setting of the user's designated value in the setting table 31 based on the subprogram.

Subsequently, the CPU 20 selects one logical volume VOL among the logical volumes VOL registered in the setting table 31, and confirms whether the a set value is stored in the “starting condition” field 121 corresponding to the logical volume in the setting table 31 (SP11). When a set value is not stored in the “starting condition” field 121 (SP11: NO), the CPU 20 proceeds to step SP16.

Contrarily, when a set value is stored in the “starting condition” field 121 (SP11: YES), the CPU 20 displays the text “Set” at a first setting status display position (position at the row where the text “Starting Condition” is displayed in the status display unit 340 of FIG. 13) corresponding to the target logical volume (this is hereinafter referred to as a “target logical volume”) VOL in the processing status display unit 340 of the referral destination volume switching processing setting/execution screen 300 (SP12).

Subsequently, the CPU 20 determines whether the set value stored in the “starting condition” field 121 of the setting table 31 is “execution” (SP13). Here, in the case of this embodiment, when the execution button 314 in the condition setting column 304 of the referral destination volume switching processing setting/execution screen 300 is selected and the enter button 309 is clicked, a set value of “Execution” is stored in the “starting condition” field 121 and the “ending condition” field 122 of the setting table 31, respectively.

Accordingly, if the set value of “execution” is stored in the “starting condition” field 121 of the setting table 31, this means that the referral destination volume switching processing has already been started regarding the target logical volume VOL. Thus, when the CPU 20 obtains a positive result in the determination at step SP13 (SP13: YES), it stores an execution target flag in the “execution target” field 127 (sets “1” in the “execution target” field 127) of the setting table 31 (SP14).

Contrarily, if the set value of “execution” is not stored in the “starting condition” field 121 of the setting table 31, this means that the referral destination volume switching processing has not yet been performed regarding the target logical volume VOL. Thus, when the CPU 20 obtains a negative result in the determination at step SP13 (SP13: NO), it activates the access monitoring program 22 of the management server 4 (SP15). Thereby, the CPU 20 will thereafter monitor the access frequency from the host system 2 to the logical volume VOL as the target volume based on the access monitoring program 22.

Subsequently, the CPU 20 determines whether there is an unprocessed logical volume VOL, which is a logical volume VOL registered in the setting table 31 but has not yet been subject to the processing of step SP11 to step SP15 described above (SP16). When the CPU 20 obtains a positive result in this determination, it returns to step SP11, and executes processing of step SP11 to step SP16 against such unprocessed logical volume VOL.

Meanwhile, when the CPU 20 eventually completes the processing of step SP11 to step SP16 against all logical volumes VOL registered in the setting table 31 (SP16: NO), it activates the volume change processing program 23 (SP17). Thereby, the CPU 20 will be able to execute the pair status-based logical volume VOL creation control processing based on the volume change processing program 23.

Subsequently, the CPU 20 selects one logical volume VOL among the logical volumes VOL registered in the setting table 31, and confirms whether a set value is stored in the “ending condition” field 122 corresponding to the logical volume VOL in the setting table 31 (SP18). When a set value is not stored in the “ending condition” field 122 (SP18: NO), the CPU 20 proceeds to step SP23.

Contrarily, when a set value is stored in the “ending condition” field 122 (SP18: YES), the CPU 20 displays the text “Set” at a second setting status display position (position at the row where the text “Ending Condition” is displayed in the status display unit 340 of FIG. 13) corresponding to the target logical volume VOL in the processing status display unit 340 of the referral destination volume switching processing setting/execution screen 300 (SP19).

Subsequently, the CPU 20 determines whether the set value stored in the “ending condition” field 122 of the setting table 31 is “execution” (SP20). To obtain a positive result in this determination means that the referral destination volume switching processing has already been started regarding the target logical volume VOL. Thus, when the CPU 20 obtains a positive result in the determination at step SP20 (SP20: YES), it sets “0” in the execution target” field 127 of the setting table 31 (SP21).

Contrarily, if the set value of “execution” is not stored in the “ending condition” field 122 of the setting table 31, this means that the referral destination volume switching processing has not yet been performed regarding the target logical volume VOL. Thus, when the CPU 20 obtains a negative result in the determination at step SP20 (SP20: NO), it activates the copy volume monitoring program 25 of the management server 4 (SP22). Thereby, the CPU 20 will thereafter monitor the access frequency from the host system 2 to the logical volume VOL pair-configured with the target logical volume VOL based on the copy volume monitoring program 25.

Subsequently, the CPU 20 determines whether there is an unprocessed logical volume VOL, which is a logical volume VOL registered in the setting table 31 but has not yet been subject to the processing of step SP18 to step SP22 described above (SP23). When the CPU 20 obtains a positive result in this determination, it returns to step SP18, and executes processing of step SP18 to step SP23 against such unprocessed logical volume VOL.

Meanwhile, when the CPU 20 eventually completes the processing of step SP18 to step SP23 against all logical volumes VOL registered in the setting table 31 (SP23: NO), it activates the volume release processing program 24 (SP24). Thereby, the CPU 20 will thereafter to execute processing for releasing the pair configuration between the target logical volume VOL and the corresponding logical volume VOL based on the volume release processing program 24.

### (2-2-5-2) Subprogram Activation Processing

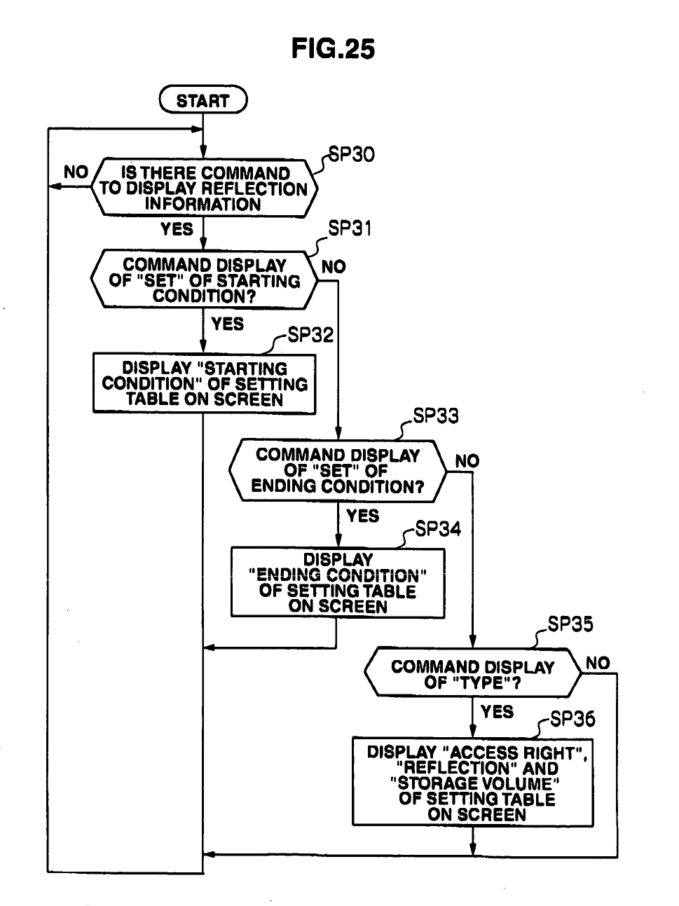

FIG. 25 is a flowchart showing the specific processing contents of the CPU 20 at step SP10 of the referral destination volume switching processing described with reference to FIG. 24.

When the CPU 20 proceeds to step SP10 of the referral destination volume switching processing, it starts the subprogram activation processing. When a subprogram is activated, as described above, by clicking the text of “Set” displayed in the status display unit 340 of the referral destination volume switching processing setting/execution screen 300, as described with reference to FIG. 17, it is possible to confirm the set contents by performing processing of displaying, in pulldown format, the contents of the starting condition or the ending condition set regarding the corresponding logical volume VOL.

Foremost, the CPU 20 confirms whether there is a command from the system administrator for reflecting and displaying information (SP30). The CPU 20 thereafter waits for a portion of the status display unit 340 to be clicked and, when clicked, determines that a command has been given by the system administrator to reflect the information (SP30: YES).

Subsequently, when the text of “Set” displayed in the status display unit 340 is clicked, the CPU 20 confirms whether such command is commanding the display of “Set” of the starting condition of the referral destination volume switching processing (SP31). If the command is commanding the display of “Set” of the starting condition (SP31: YES), the CPU 20 displays the information set in the “starting condition” of the setting table 31 regarding the corresponding logical volume VOL on the screen in a pulldown format (SP32). Meanwhile, if the command is not commanding the display of “Set” of the starting condition (SP31: NO), the CPU 20 confirms whether the command is command the display of “Set” of the ending condition (SP33). If the command is commanding the display of “Set” of the ending condition (SP33: YES), the CPU 20 displays the information set in the “ending condition” of the setting table 31 regarding the corresponding logical volume VOL on the screen in a pulldown format (SP34).

Or, if the command from the system administrator to reflect the information is not commanding the display of “Set” of the ending condition (SP33: NO), and the text (“Pair in Execution” or “Non-pair in Execution”, etc.) displayed in the status display unit 340 is clicked, the CPU 20 confirms whether the command from the system administrator to reflect the information is commanding the display of the “type” mode (SP35). If the command is commanding the display of the “type” mode (SP35: YES), the CPU 20 displays the setting information relating to the “access right”, “reflection”, and “storage volume” of the setting table 31 on the screen in a pulldown format (SP36). Thereby, the CPU 20 thereafter returns to the “starting condition” field 121 of the setting table 31, and confirms whether the starting conditions have been set (SP11). Meanwhile, when there is no command from the system administrator to reflect the information (SP30: NO; SP33: NO; SP35: NO), the CPU 20 waits until such reflection command is given, returns to step SP30 when such reflection command is given, and executes the processing of step SP30 to step SP36.

### (2-2-5-3) Access Monitoring Processing

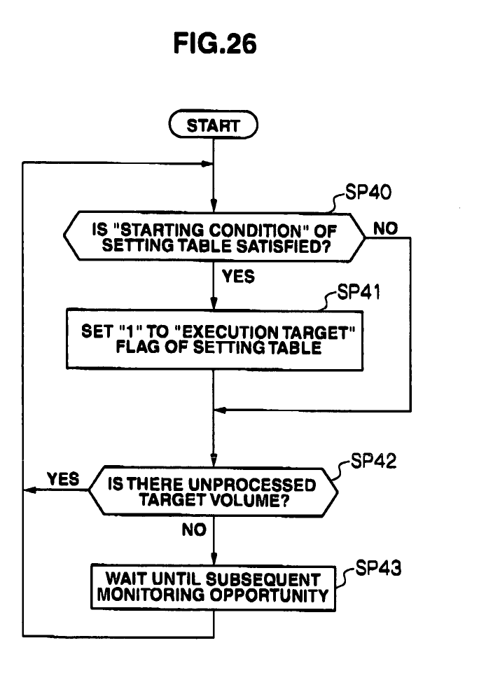

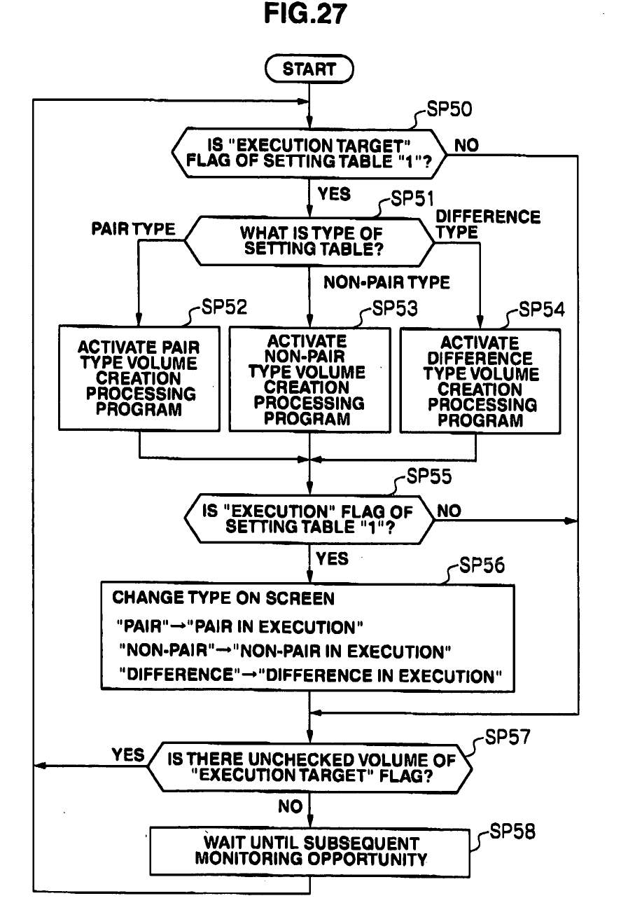

Meanwhile, FIG. 26 is a flowchart showing the specific processing contents of the CPU 20 relating to the access monitoring processing to be performed based on the access monitoring program 22 activated at step SP15 of the referral destination volume switching processing described with reference to FIG. 24. The CPU 20, based on the activated access monitoring program 22, determines whether to execute the processing for changing the referral destination of the target logical volume VOL according to the processing routine shown in FIG. 26.

In other words, when the CPU 20 activates the access monitoring program 22 at step SP 15 of the referral destination volume switching processing, it starts this access monitoring processing in parallel with the referral destination volume switching processing described with reference to FIG. 24, and, foremost, refers to the setting table 31 regarding the logical volume VOL registered in the target setting table 31, and determines whether the starting condition stored in the corresponding “starting condition” field 121 in the setting table 31 is currently satisfied (SP40).

When the CPU 20 determines that the starting condition is not satisfied (SP40: NO), it proceeds to step SP42, and, contrarily, when the CPU 20 determines that the starting condition is satisfied (SP40: YES), it sets “1” in the corresponding “execution target” field 127 of the setting table 31 (SP41).

Subsequently, the CPU 20 determines whether there is a logical volume VOL registered in the setting table 31 but has not yet been subject to the determination at step SP40 (SP42). When the CPU 20 obtains a positive result in this determination (SP42: YES), it thereafter returns to step SP40, and repeats similar processing steps while sequentially switching the target logical volume VOL to another logical volume VOL registered in the setting table 31 (step SP40 to step SP42).

When the CPU 20 eventually completes performing the similar processing steps regarding all logical volumes VOL registered in the setting table 31 (SP42: NO), it further waits for the subsequent monitoring opportunity such as when a new logical volume VOL is set in the setting table 31 (SP43). When the subsequent monitoring opportunity eventually arrives, the CPU 20 returns to step SP40, and thereafter repeats the same processing steps (SP40 to SP43).

### (2-2-5-4) Volume Change Processing

### (2-2-5-4-1) Volume Change Processing

Meanwhile, FIG. 27 is a flowchart showing the specific processing contents of the CPU 20 relating to the volume change processing to be performed based on the volume change processing program 23 activated at step SP17 of the referral destination volume switching processing described with reference to FIG. 24. The CPU 20 executes, based on the activated volume change processing program 23, the processing for changing the logical volume VOL of the referral destination regarding the target logical volume VOL according to the processing routine shown in FIG. 27.

In other words, when the CPU 20 activates the volume change processing program 23 at step SP17 of the referral destination volume switching processing, it starts this volume change processing in parallel with the referral destination volume switching processing, and, foremost, confirms whether an execution target flag is stored in the logical volume VOL in the setting table 31 and the corresponding “execution target” field 127 (“1” is set in the “execution target” field 127) regarding the logical volume VOL registered in the setting table 31 (SP50).

Here, if an execution target flag is not stored in the “execution target” field 127 (if “1” is not set in the “execution target” field 127) of the setting table 31 associated with the logical volume VOL (SP50: NO), this means that the starting condition set regarding the logical volume VOL is not satisfied or the referral destination volume switching processing performed against the logical volume VOL is not complete. Thereby, the CPU 20 proceeds to step SP57 in the foregoing case.

Contrarily, if an execution target flag is not stored in the “execution target” field 127 of the setting table 31 associated with the logical volume VOL (SP50: YES), this means that the starting condition set regarding the logical volume VOL is satisfied. Thereby, the CPU 20 refers to the “type” field 123 in the setting table 31 associated with the logical volume VOL, and confirms the pair status of the copy pair set regarding the logical volume VOL (SP51).

When the pair status set regarding the logical volume VOL is a pair type, the CPU 20 activates the pair type volume creation processing program in correspondence with such setting (SP52). Further, when the pair status set regarding the logical volume VOL is a non-pair type, the CPU 20 activates the non-pair type volume creation processing program in correspondence with such setting (SP53). Further still, when the pair status set regarding the logical volume VOL is a difference type, the CPU 20 activates the difference type volume creation processing program in correspondence with such setting (SP54).

The CPU 20 thereafter determines whether an execution flag is stored in the execution field 128 (“1” is set in the “execution” field 128) in the setting table 31 associated with the logical volume VOL (SP55).

To obtain a negative result in this determination (SP55: NO) means that the referral destination volume switching processing is not being executed against the logical volume VOL. Thereby, the CPU 20 proceeds to step SP57 in the foregoing case.

Contrarily, to obtain a position result in the determination at step SP55 means that the logical volume VOL is being executed. Thereby, the CPU 20 changes the text displayed at a type display position (position at the row displaying the text “Type” in the status display unit 340 of FIG. 13) associated with the logical volume VOL in the status display unit 340 of the referral destination volume switching processing setting/execution screen 300 from “pair” to “pair in execution” when the pair status set regarding the logical volume VOL is a pair type, changes the text from “non-pair” to “non-pair in execution” when the pair status is a non-pair type, and changes the text from “difference” to “difference in execution” when the pair status is a difference type (SP56).

The CPU 20 thereafter determines whether there is a logical volume VOL registered in the setting table 31 but has not yet been subject to the foregoing processing of step SP50 to step SP55 (SP57).

When the CPU 20 obtains a positive result in this determination (SP57: YES), it returns to step SP50, and repeats similar processing steps while sequentially switching the target logical volume VOL to another logical volume VOL registered in the setting table 31 (step SP50 to step SP56).

When the CPU 20 eventually completes performing the similar processing steps regarding all logical volumes VOL registered in the setting table 31 (SP57: NO), it further waits for the subsequent monitoring opportunity such as when a new logical volume VOL is set in the setting table 31 (SP58). When the subsequent monitoring opportunity eventually arrives, the CPU 20 returns to step SP50, and thereafter repeats the same processing steps (SP50 to SP57).

### (2-2-5-4-2) Pair Type Volume Creation Processing

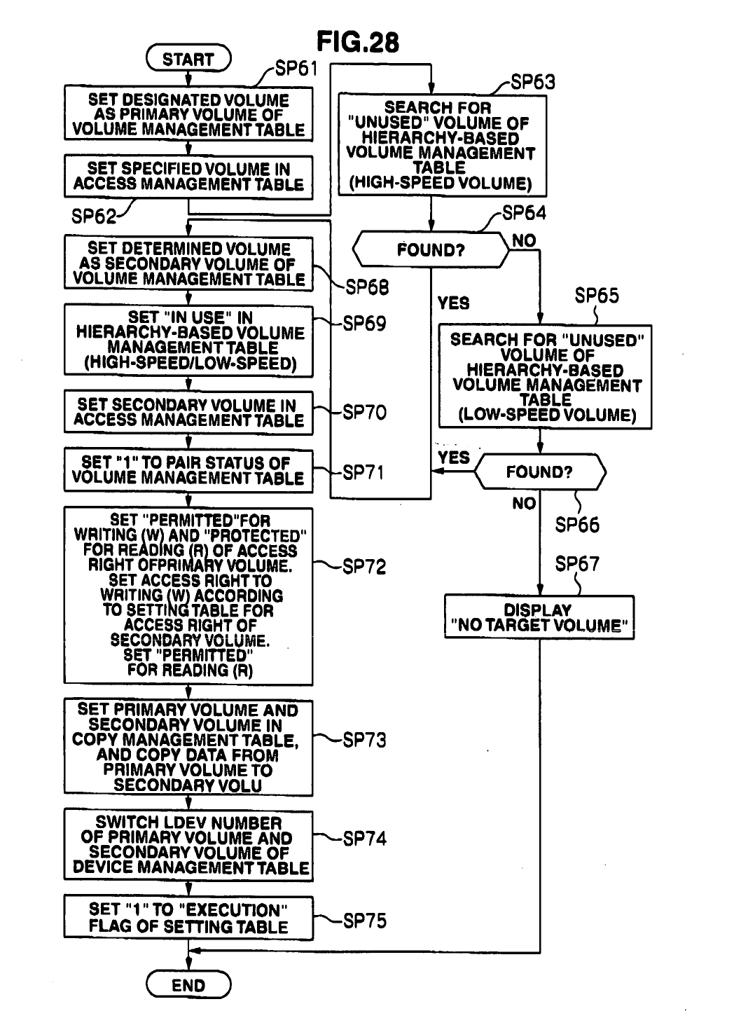

FIG. 28 is a flowchart showing the specific processing contents of the CPU 20 relating to the pair type volume creation processing to be performed based on the pair type volume creation processing program 33 activated at step SP52 of the volume change processing described with reference to FIG. 27. The CPU 20 executes, based on the pair type volume creation processing program 33, the pair type volume creation processing for creating a copy pair of the pair type regarding the target logical volume VOL according to the processing routine shown in FIG. 28.

In other words, when the CPU 20 proceeds to step SP52 of the volume change processing (FIG. 27), it starts the pair type volume creation processing, and, foremost, registers the target logical volume VOL in the volume management table 32 as a logical volume of the copy source (this is hereafter referred to as a “primary volume” as appropriate) VOL (SP61). Further, the CPU 20 thereafter controls the corresponding storage apparatus 3 so as to register the target logical volume VOL in the access management table 46 of the storage apparatus 3 (SP62).

Subsequently, the CPU 20 refers to the high-speed hierarchy-based volume management table 30A, and searches for an unused high-speed logical volume VOL that could become the logical volume VOL of the copy destination of data stored in the target logical volume VOL (SP63).

As a result of this search, if the CPU 20 could not find a logical volume VOL that could become the logical volume VOL of the copy destination (SP64: NO), it refers to the low-speed hierarchy-based volume management table 30B, and searches for an unused low-speed logical volume VOL that could become the logical volume VOL of the copy destination of data stored in the target logical volume VOL (SP65).

As a result of this search, if the CPU 20 could not find a logical volume VOL that could become the logical volume VOL of the copy destination (SP66: NO), it displays a warning 345E such as “no target volume” in the status display unit 340 of the referral destination volume switching processing setting/execution screen 300 (SP67), and ends this pair type volume creation processing.

Contrarily, when the CPU 20 finds an unused high-speed logical volume VOL or an unused low-speed logical volume VOL that could become the logical volume VOL of the copy destination of data stored in the target logical volume VOL (SP64: YES; SP66: YES), it registers the high-speed logical volume VOL or the low-speed logical volume VOL in the volume management table 31 as a logical volume (this is hereinafter referred to as a “secondary volume” as appropriate) VOL of the copy destination of data stored in the target logical volume VOL (SP68).

The CPU 20 thereafter stores information of “in use” in the “used/unused” field 115 (FIG. 9, FIG. 10) associated with theological volume VOL registered in the volume management table 32 as the secondary volume VOL in the high-speed hierarchy-based volume management table 30A or the low-speed hierarchy-based volume management table 30B (SP69).

Subsequently, the CPU 20 controls the storage apparatus 3 so as to register the secondary volume VOL pertaining to the access management table 46 (FIG. 2) (SP70), and thereafter sets “1” signifying that the pair status set in the copy pair of the primary volume VOL and the secondary volume VOL is a pair type in the corresponding “pair status” field 104 (FIG. 12) of the volume management table 32 (FIG. 1) (SP71).

Further, the CPU 20 controls the CPU 41 in the corresponding storage apparatus 3 so as to set the access right of the primary volume VOL and the secondary volume VOL in the access management table 46 (FIG. 5).

Specifically, the CPU 20 stores the volume number of the primary volume VOL and the secondary volume VOL in the corresponding “volume number” field 131 in the access management table 46, and stores information representing “permitted” in the “data writability management (W)” field 133 and stores information representing “protected” in the “data readability management (R)” field 132 corresponding to the primary volume VOL. The CPU 20 further stores information of “permitted” or “protected” as the same contents of the access right field 124 set in the setting table 31 in the “data writability management (W)” field 133 corresponding to the secondary volume VOL. Incidentally, information representing “permitted” is stored in the “data readability management (R)” field 132 associated with the secondary volume VOL in the access management table 46 (SP72).

The CPU 20 thereafter controls the storage apparatus 3 so as to register the primary volume VOL and the secondary volume VOL in the “copy source” field 129 and the “copy destination” field 130 of the copy management table 45, and copies the data of the primary volume VOL to the secondary volume VOL (SP73).

When this copying is complete, the CPU 20 controls the storage apparatus 3 so as to switch the volume number of the primary volume VOL and the volume number of the secondary volume VOL in the device management table 47. In other words, by leaving the respective volume numbers of the primary volume VOL and the secondary volume VOL stored in the “volume number” field 134 of the device management table 47 as is, and switching the logical device (LDEV) numbers stored in the “LDEV number” field 135, it is possible to switch the volume numbers of the primary volume VOL and the secondary volume VOL (SP74).

For instance, with the example shown in FIG. 6, with the logical volume VOL having a volume number of “1:61” as the primary volume VOL and the logical volume VOL having a volume number of “5:0A” as the secondary volume VOL, the primary volume VOL is associated with the logical devices 53 respectively having the LDEV numbers of “L001” and “L002”, and the secondary volume VOL is associated with the logical devices 53 respectively having the LDEV numbers of “L010” and “L011”. Simultaneously, the access rights in the access management table 46 are also switched.

The CPU 20 thereafter sets “1” to the execution flag in the “execution” field 128 of the setting table 31 (SP75), and then ends this pair type volume creation processing.

Incidentally, although not described in the flowchart of FIG. 28, processing of the data I/O program after the execution of the volume change processing program 23 in the pair type is now explained. This is processing including the data I/O from the host system 2 arising before the execution of the pair type volume release processing based on the copy volume monitoring program 25 described later after the execution of the volume change processing program 23.

Upon receiving a data write request from the host system 2 for writing data in the primary volume VOL, the CPU 41 (FIG. 2) of the storage apparatus 3 refers to the “pair status” field 104 of the primary volume VOL of the volume management table 32. Here, “1” representing the pair type is stored in the “pair status” field 104 of the volume management table 32. Thus, the CPU 41 further refers to the copy management table 45 and recognizes that the primary volume VOL and the secondary volume VOL are forming a copy pair.

By further referring to the access management table 46, the CPU 41 confirms that information signifying “permitted” is stored in the “data writability management (W)” field 133 associated respectively with the primary volume VOL and the secondary volume VOL. The CPU 41 writes data from the host system 2 in both the primary volume VOL and the secondary volume VOL based on the confirmed results.

Meanwhile, when the CPU 41 of the storage apparatus 3 receives a read request from the host system 2 for reading data from the primary volume VOL, it refers to the “pair status” field 104 associated with the primary volume VOL in the volume management table 32 (FIG. 12). Since “1” is stored in the “pair status” field 104, the CPU 41 refers to the copy management table 45, and recognizes that the primary volume VOL and the secondary volume VOL are forming a pair.

The CPU 41 then refers to the access management table 32 based on the recognized results. Here, since information representing “permitted” is stored in the “data readability management (R)” field 132 associated with the secondary volume VOL in the access management table 32 and information representing “protected” is stored in the “data readability management (R)” field 132 associated with the primary volume VOL, the CPU 41 will read data from the permitted secondary volume VOL.

Like this, the CPU 41 (FIG. 2) of the storage apparatus 3 writes data in both the primary volume VOL and the secondary volume VOL, and data is read from the secondary volume VOL.

### (2-2-5-4-3) Non-Pair Type Volume Creation Processing

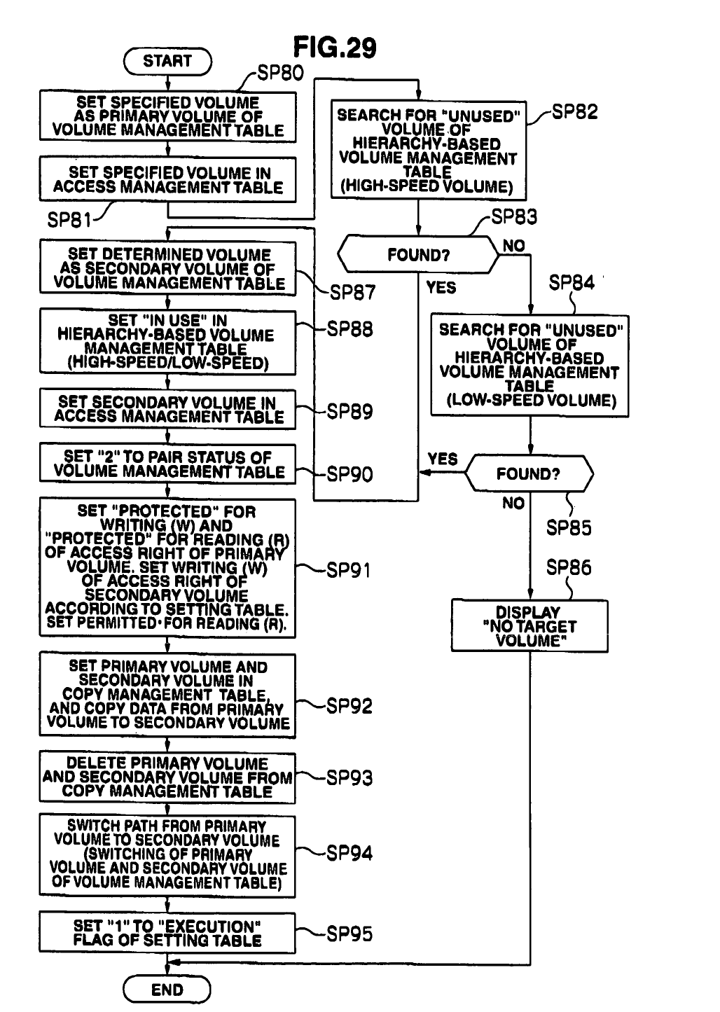

Meanwhile, FIG. 29 is a flowchart showing the specific processing contents of the CPU 20 relating to the non-pair type volume creation processing to be performed based on the non-pair type volume creation processing program 34 activated at step SP53 of the volume change processing described with reference to FIG. 27. The CPU 20 executes, based on the non-pair type volume creation processing program 34, the non-pair type volume creation processing for creating a copy pair of the non-pair type regarding the target logical volume VOL according to the processing routine shown in FIG. 29.

In other words, when the CPU 20 proceeds to step SP53 of the volume change processing (FIG. 27), it starts the non-pair type volume creation processing, and performs step SP80 to step SP89 as with the processing of step SP61 to step SP70 of the pair type volume creation processing described with reference to FIG. 28.

The CPU 20 thereafter sets “2” signifying that the pair status set in the copy pair of the primary volume VOL and the secondary volume VOL is a non-pair type in the corresponding “pair status” field 104 (FIG. 12) of the volume management table 32 (FIG. 1) (SP90).

Further, the CPU 20 (FIG. 1) controls the CPU 41 (FIG. 2) in the corresponding storage apparatus 3 so as to set the access right of the primary volume VOL and the secondary volume VOL in the access management table 46 (FIG. 5).

Specifically, the CPU 20 stores the volume number of the primary volume VOL and the secondary volume VOL in the corresponding “volume number” field 131 in the access management table 46, and stores information representing “protected” in the “data writability management (W)” field 133 and the “data readability management (R)” field 132 corresponding to the primary volume VOL.

The CPU 20 further stores information of “permitted” or “protected” as the same contents of the “access right” field 124 set in the setting table 31 in the “data writability management (W)” field 133 corresponding to the secondary volume VOL. Incidentally, information representing “permitted” is stored in the “data readability management (R)” field 132 associated with the secondary volume VOL in the access management table 46 (SP91).

The CPU 20 thereafter controls the storage apparatus 3 so as to register the primary volume VOL and the secondary volume VOL in the “copy source” field 129 and the “copy destination” field 130 of the copy management table 45, and copies the data of the primary volume VOL to the secondary volume VOL (SP92).

When this copying is complete, the CPU 20 deletes the respective volume numbers of the primary volume VOL [symbol] secondary volume VOL from the “copy source” field 129 and the “copy destination” field 130 of the copy management table 45 (SP93).

Further, the CPU 20 changes the access path set from the host system 2 to the primary volume VOL to an access path from the host system 2 to the secondary volume VOL using the path connection information table 14. Pursuant to this change, the volume numbers of the “primary volume” field 100 and the “secondary volume” field 101 of the volume management table 32 are also switched (SP94).

Further, the CPU 20 stores an execution flag in the corresponding “execution” field 128 (sets “1” in the “execution” field 128) of the setting table 31 (SP95), and thereafter ends this non-pair type volume creation processing.

Incidentally, although not described in the flowchart of FIG. 29, processing of the data I/O program after the execution of the volume change processing program 23 in the non-pair type is now explained. This is processing including the data I/O from the host system 2 arising before the execution of the non-pair type volume release processing based on the copy volume monitoring program 25 described later after the execution of the volume change processing program 23.

Upon receiving a data write request from the host system 2 for writing data in the primary volume VOL, the CPU 41 (FIG. 2) of the storage apparatus 3 refers to the “pair status” field 104 of the primary volume VOL of the volume management table 32. Here, “2” representing the non-pair type is stored in the “pair status” field 104 of the volume management table 32.

The CPU 41 further refers to the copy management table 45, and recognizes that the primary volume is not registered in the copy management table 45. Thus, by further referring to the access management table 46, the CPU 41 confirms whether information signifying “permitted” is stored in the “data writability management (W)” field 133 associated with the primary volume VOL. The CPU 41 writes data from the host system 2 in the primary volume VOL based on the confirmed results.

Meanwhile, when the CPU 41 of the storage apparatus 3 receives a read request from the host system 2 for reading data from the primary volume VOL, it refers to the “pair status” field 104 associated with the primary volume VOL in the volume management table 32 (FIG. 12). Since “2” is stored in the “pair status” field 104, the CPU 41 refers to the copy management table 45. Since the primary volume is registered in the copy management table 45, the CPU 41 recognizes that the primary volume VOL is not registered in the copy management table 45.

Thus, by referring to the access management table 46, the CPU 41 confirms that information signifying “permitted” is stored in the “data readability management (R)” field 132 associated with the primary volume VOL. The CPU 41 thereby reads data from a permitted primary volume VOL based on the confirmed results.

### (2-2-5-4-4) Difference-Type Volume Creation Processing

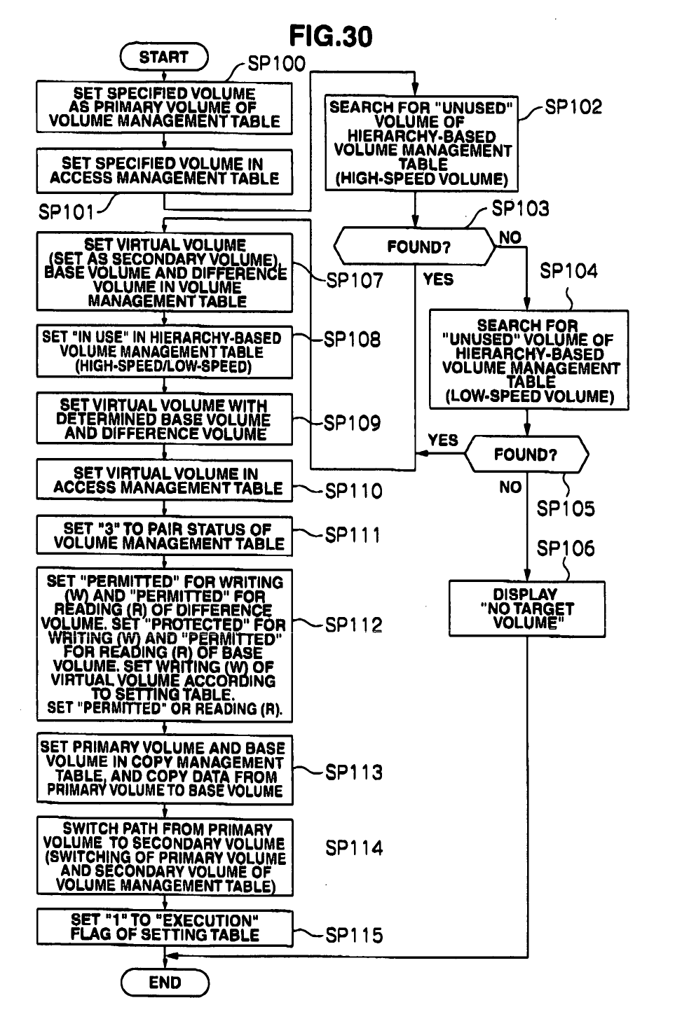

Meanwhile, FIG. 30 is a flowchart showing the specific processing contents of the CPU 20 relating to the difference type volume creation processing to be performed based on the difference type volume creation processing program 35 activated at step SP54 of the volume change processing described with reference to FIG. 27. The CPU 20 executes, based on the difference type volume creation processing program 35, the difference type volume creation processing for creating a copy pair of the difference type regarding the target logical volume VOL according to the processing routine shown in FIG. 30.

In other words, when the CPU 20 proceeds to step SP54 of the volume change processing (FIG. 27), it starts the difference type volume creation processing, and performs step SP100 to step SP101 as with the processing of step SP61 to step SP70 of the pair type volume creation processing described with reference to FIG. 28.

When the CPU 20 thereafter finds an unused high-speed logical volume VOL or an unused low-speed logical volume VOL of the copy destination of data stored in the target logical volume VOL (SP64: YES; SP66: YES), it stores such high-speed logical volume VOL or low-speed logical volume VOL as the logical volume VOL of the copy destination of data stored in the target logical volume VOL, and stores the virtual volume VOL, base volume VOL and difference volume VOL as the secondary volume VOL in the volume management table 32 (SP108).

The CPU 20 thereafter stores information of “in use” in the “used/unused” field 115 (FIG. 9, FIG. 10) associated with the logical volume VOL registered in the volume management table 32 as the logical volume VOL stored in the volume management table 31 as the secondary volume VOL in the high-speed hierarchy-based volume management table 30A or the low-speed hierarchy-based volume management table 30B (SP109).

Subsequently, the CPU 20 sets a virtual volume VOL having the decided base volume VOL and difference volume VOL (SP109), and further controls the storage apparatus 3 so as to register the virtual volume VOL as the secondary volume in the access management table 46 (FIG. 2) (SP110), and thereafter sets “3” signifying that the pair status set as the copy pair of the primary volume VOL and the secondary volume VOL is a difference type in the corresponding “pair status” field 104 (FIG. 12) in the volume management table 32 (FIG. 1) (SP111).

The CPU 20 further controls the CPU 41 in the corresponding storage apparatus 3 so as to set the access right of the respective logical volumes VOL in the access management table 46 (FIG. 5).

Specifically, the CPU 20 respectively stores information representing “permitted” in the “data writability management (W)” field 133 and the “data readability management (R)” field 132 corresponding to the difference volume VOL in the access management table 46. The CPU 20 further stores information representing “protected” in the “data writability management (W)” field 133 corresponding to the base volume VOL. The CPU 20 further stores information representing “permitted” in the “readability management (R)” field 132 corresponding to the base volume VOL.

The CPU 20 further stores information of “permitted” or “protected” as the same contents of the access right field 124 set in the setting table 31 in the “data writability management (W)” field 133 corresponding to the virtual volume VOL. Incidentally, information representing “permitted” is stored in the “data readability management (R)” field 132 associated with the secondary volume VOL in the access management table 46 (SP112).

The CPU 20 thereafter controls the storage apparatus 3 so as to register the primary volume VOL and the base volume VOL in the “copy source” field 129 and the “copy destination” field 130 of the copy management table 45, and copies the data of the primary volume VOL to the base volume VOL (SP113).

Further, the CPU 20 changes the access path set from the host system 2 to the primary volume VOL to an access path from the host system 2 to the virtual volume VOL using the path connection information table 14. Pursuant to this change, the volume numbers of the “primary volume” field 100 and the “secondary volume” field 101 of the volume management table 32 are also switched (SP114).

Further, the CPU 20 stores an execution flag in the “execution” field 128 of the setting table 31 (SP115), and thereafter ends this difference type volume creation processing.

Incidentally, although not described in the flowchart of FIG. 30, processing of the data I/O program after the execution of the volume change processing program 23 in the difference type is now explained. This is processing including the data I/O from the host system 2 arising before the execution of the difference type volume release processing based on the copy volume monitoring program 25 described later after the execution of the volume change processing program 23.

Upon receiving a data write request from the host system 2 for writing data in the primary volume VOL, the CPU 41 (FIG. 2) of the storage apparatus 3 refers to the “pair status” field 104 of the primary volume VOL of the volume management table 32. Here, “3” representing the difference type is stored in the “pair status” field 104 of the volume management table 32. Thus, the CPU 41 recognizes that the virtual volume VOL is subject to write-protect, and writes data in the difference volume VOL.

Further, since the bitmap 210 (FIG. 23) is associated with the virtual volume VOL, the CPU 41 sets “1” in the corresponding portion of the bitmap when a new write request for writing data in a certain logical block of the virtual volume VOL is issued.

When a data read request is given from the host system 2 for reading data from the virtual volume VOL, the CPU 41 refers to the bitmap 210 to check whether the corresponding logical block has been changed, and, since the data has been changed if the corresponding value of the bitmap (FIG. 23) is “1”, the CPU 41 reads data from the difference volume VOL and sends it to the host system 2. Meanwhile, since data has not been changed if the corresponding value of the bitmap 210 is “0”, the CPU 41 reads data from the base volume VOL and sends it to the host system 2.

### (2-2-5-5) Copy Volume Monitoring Processing

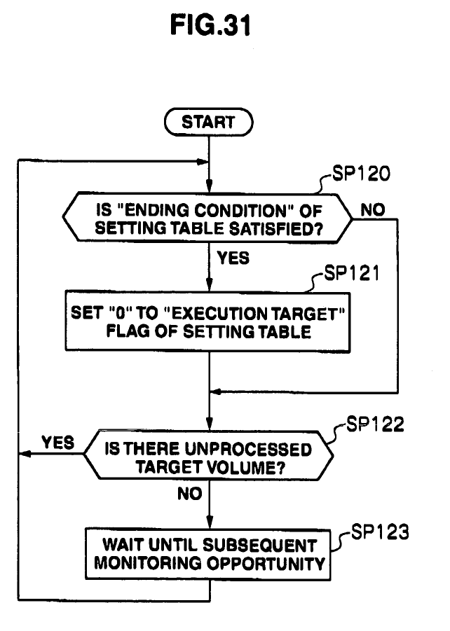

FIG. 31 is a flowchart showing the specific processing contents of the CPU 20 relating to the copy volume monitoring processing to be performed based on the copy volume monitoring program 25 activated at step SP22 of the referral destination volume switching processing described with reference to FIG. 24. The CPU 20, based on the activated copy volume monitoring program 25, monitors the access frequency of the host system 2 to the logical volume VOL of the copy destination to which data of the target logical volume VOL was copied according to the processing routine shown in FIG. 31.

In other words, when the CPU 20 activates the copy volume monitoring program 25 at step SP 22 of the referral destination volume switching processing, it starts this copy volume monitoring processing based on the copy volume monitoring program 25, and foremost confirms whether the ending condition set in the setting table 31 is satisfied (SP120). When the condition is satisfied (SP120: YES), the CPU 20 sets “0” in the execution target flag of the “execution target” field 127 in the setting table 31 (SP121).

Meanwhile, when “0” is set in the execution target flag of the “execution target” field 127 in the setting table 31 (SP121), or when the ending condition set in the setting table 31 is not satisfied (SP120: NO), the CPU 20 determines whether there is an unprocessed logical volume VOL that is a logical volume VOL registered in the setting table 31 but has not yet been subject to the processing of step SP120 to step SP121 described above (SP122).

When the CPU 20 obtains a positive result in this determination (SP122: YES), it returns to step SP120 and executes the processing of step SP120 and step SP121 against such unprocessed logical volume VOL.

When the CPU 20 eventually completes performing the similar processing steps regarding all logical volumes VOL registered in the setting table 31 (SP122: NO), it further waits for the subsequent monitoring opportunity (SP123).

### (2-2-5-6) Volume Release Processing

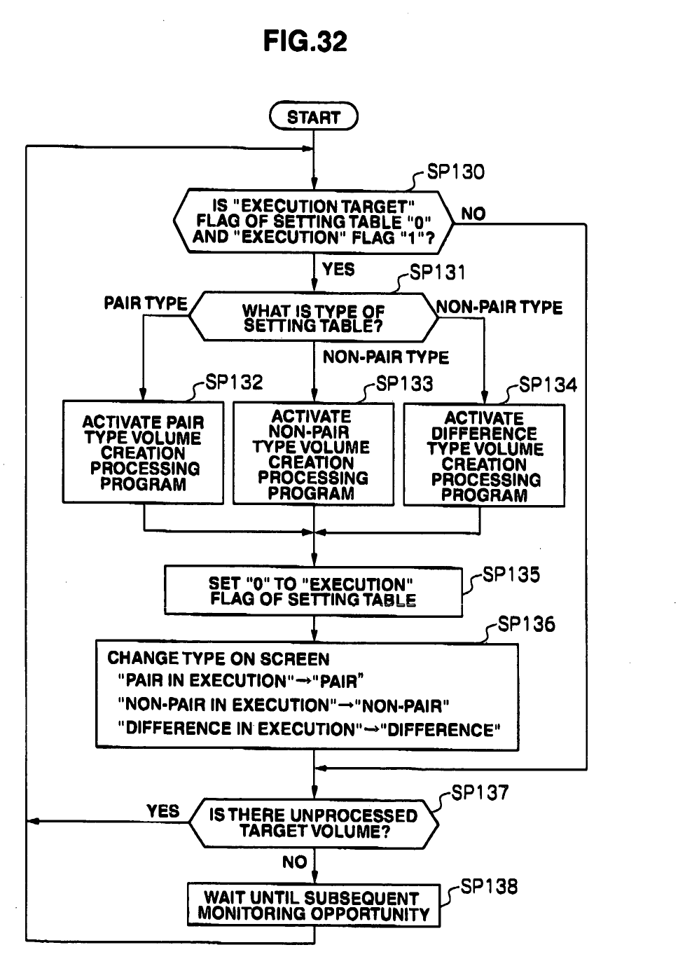

FIG. 32 is a flowchart showing the specific processing contents of the CPU 20 relating to the volume release processing to be performed based on the volume release processing program 24 activated at step SP24 of the referral destination volume switching processing described with reference to FIG. 24. The CPU 20 executes, based on the activated volume release processing program 24, the processing for changing the logical volume VOL of the referral destination regarding the target logical volume VOL according to the processing routine shown in FIG. 32.

The CPU 20 foremost confirms whether “0” is stored in the execution target flag of the setting table 31 (“0” is set in the “execution target” field 127 of the setting table 31), and “1” is stored in the execution flag (“1” is set in the “execution target” field 127 of the setting table 31) (SP130). When the CPU 20 obtains a positive result in this determination (SP130: YES), this means that the ending condition is satisfied or the referral destination volume switching processing is being executed in the setting table 31.

Subsequently, after the CPU 20 refers to the setting table 31 for the foregoing confirmation, it further refers to the “type” field 123 in the setting table 31, and confirms the pair status selected by the system administrator (SP131). When a pair status is selected by the system administrator, the CPU 20 activates the pair type volume release processing program 24 (SP132), activates the non-pair type volume release processing program 24 when the non-pair pair status is selected (SP133), and actives the difference type volume release processing program 24 when a difference type pair status is selected (SP134).

After the CPU 20 activates the volume release processing program 24 according to the pair status selected in the “type” field 123 of the setting table 31, it sets “0” in the “execution” field 128 of the setting table 31 (SP135).

Thereby, after storing “0” in the execution flag of the setting table 31, the CPU 20 changes the text displayed at a type display position (position at the row displaying the text “Type” in the status display unit 340 of FIG. 13) associated with the target logical volume VOL in the status display unit 340 of the referral destination volume switching processing setting/execution screen 300 from “pair in execution” to “pair” when the pair status set regarding the logical volume VOL is a pair type, changes the text from “non-pair in execution” to “non-pair” when the pair status is a non-pair type, and changes the text from “difference in execution” to “difference” when the pair status is a difference type (SP136).

After making the foregoing change, the CPU 20 determines whether there is an unprocessed logical volume VOL which is a logical volume VOL registered in the setting table 31 but has not yet been subject to the processing of step SP130 to step SP136 described above (SP137). When the CPU 20 obtains a positive result in this determination (SP137: YES), it returns to step SP130 and executes the processing of step SP130 to step SP136 against such unprocessed logical volume VOL. Meanwhile, when the CPU 20 eventually completes performing the similar processing steps regarding all logical volumes VOL registered in the setting table 31 (SP137: NO), it further waits for the subsequent monitoring opportunity (SP138).

### (2-2-5-1) Pair Status Volume Release Processing

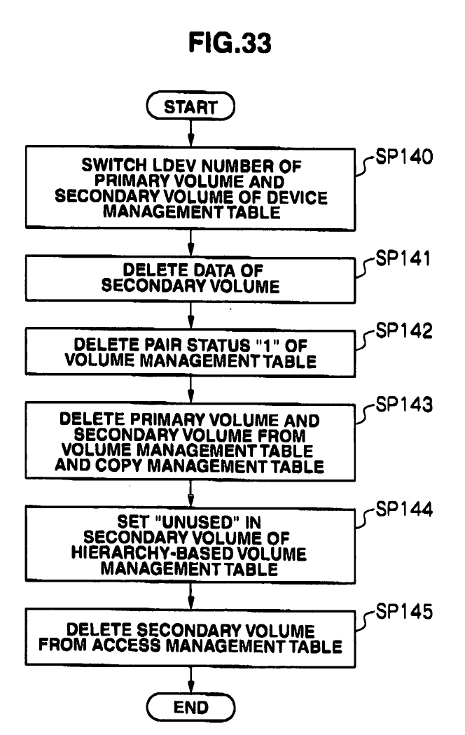

FIG. 33 is a flowchart showing the specific processing contents of the CPU 20 relating to the pair type volume release processing to be performed based on the pair type volume release processing program 24 activated at step SP132 of the volume release processing described with reference to FIG. 32. The CPU 20 executes, based on the pair type volume release processing program 24, the pair type volume release processing for releasing the copy pair of the pair type regarding the target logical volume VOL according to the processing routine shown in FIG. 33.

In other words, when the CPU 20 proceeds to step SP132 of the volume release processing (FIG. 32), it starts this pair type volume release processing, and foremost controls the storage apparatus 3 so as to switch the volume ID of the primary volume VOL and the volume ID of the secondary volume VOL using the “volume” field 134 and the “LDEV number” field 135 in the device management table 47.

In other words, the CPU 20 switches the identifiers of the primary volume VOL and the secondary volume VOL by leaving the respective volume numbers of the primary volume VOL and the secondary volume VOL stored in the “volume number” field 134 of the device management table 47 as is, and switching the logical device (LDEV) numbers stored in the “LDEV number” field 135 (SP140).

Specifically, for instance, during the explanation of the pair type volume creation processing program in FIG. 28, processing for returning the processing performed at step SP74 to its original state is performed. In other words, at step SP74, with the logical volume VOL having a volume number of “1:01” as the primary volume VOL and the logical volume VOL having a volume number of “5:0A” as the secondary volume VOL, the primary volume VOL is associated with the logical devices 53 respectively having the LDEV numbers of “L001” and “L002”, and the secondary volume VOL is associated with the logical devices 43 respectively having the LDEV numbers of “L010” and “L011”.

At step SP140 of the volume release processing, opposite to the above, the primary volume VOL is associated with the logical devices 53 respectively having the LDEV numbers of “L010” and “L011”, and the secondary volume VOL is associated with the logical devices 53 respectively having the LDEV numbers of “L001” and “L002”. Simultaneously, the access rights are also switched using the “volume number” field 131, “data readability management (R)” field 132 and “data writability management (W)” field 133 in the access management table 46.

After performing the foregoing identifier changing processing, the CPU 20 deletes the data stored in the secondary volume VOL from the secondary volume VOL (SP141). The CPU 20 further deletes “1” representing the pair type from the “pair status” field 104 of the volume management table 32 (SP142).

Further, by deleting the volume IDs of the primary volume VOL and the secondary volume VOL stored in the “primary volume” field 100 and the “secondary volume” field 101 of the volume management table 32, the CPU 20 deletes the primary volume VOL and the secondary volume VOL from the copy management table 45 (SP143).

The CPU 20 further sets “unused” in the “used/unused” field 115 associated with the secondary volume VOL in the hierarchy-based volume management table 30A or the hierarchy-based volume management table 30B (SP144).

Further, by controlling the storage apparatus 3 and deleting the volume numbers corresponding to the primary volume VOL and the secondary volume VOL from the “volume number” field 131 of the access management table 46, the CPU 20 deletes the secondary volume VOL from the access management table 46 (SP145). Thereby, the CPU 20 ends the pair status volume release processing.

### (2-2-5-6-2) Non-Pair Status Volume Release Processing

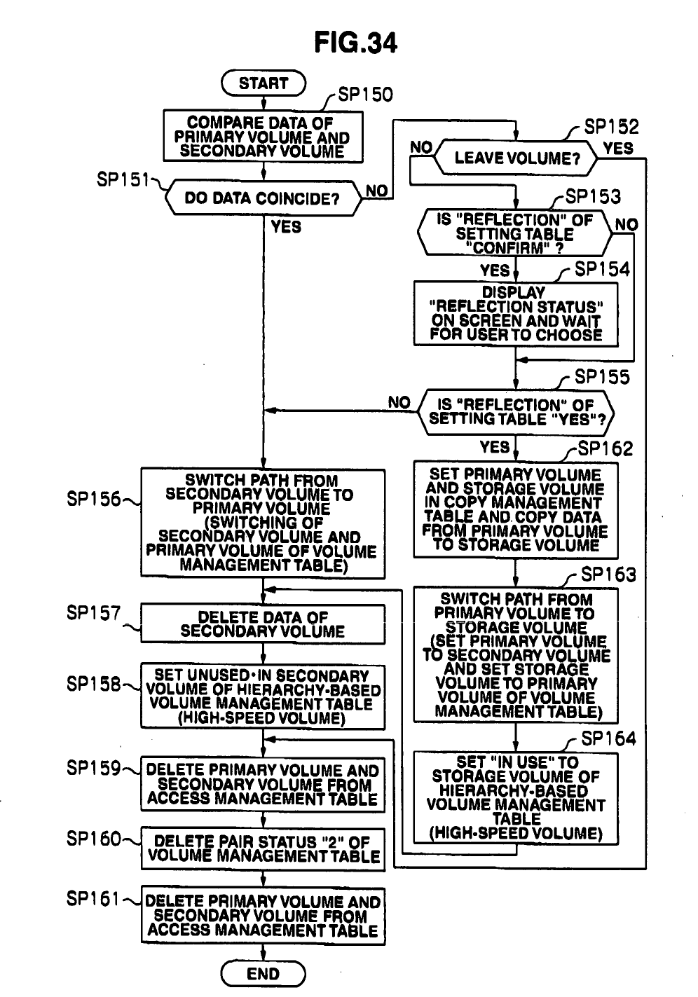

FIG. 34 is a flowchart showing the specific processing contents of the CPU 20 relating to the non-pair type volume release processing to be performed based on the non-pair type volume release processing program 24 activated at step SP133 of the volume release processing described with reference to FIG. 32. The CPU 20 executes, based on the non-pair type volume release processing program 24, the non-pair type volume release processing for releasing the copy pair of the non-pair type regarding the target logical volume VOL according to the processing routine shown in FIG. 34.

In other words, when the CPU 20 proceeds to step SP133 of the volume release processing (FIG. 32), it starts this non-pair type volume release processing, and foremost compares the data stored in the primary volume VOL and the data stored in the secondary volume VOL (SP150).

When the data stored in the primary volume VOL and the data stored in the secondary volume VOL do not coincide (SP151: NO), the CPU 20 inquires the system administrator (user) to confirm whether to leave the secondary volume VOL (SP152).

When a command is given from the system administrator to not leave the secondary volume VOL (SP152: NO), the CPU 20 confirms whether the “reflection” field 125 of the setting table 31 is “Confirm” (SP153), and, when it is “Confirm” (SP153: YES), the CPU 20 displays the reflection status setting column 306 in the condition setting unit 303 on the referral destination volume switching processing setting/execution screen 300, and waits for the system administrator to select either the YES button 329 or the NO button 330 (SP154).

When the system administrator eventually selects either the YES button 329 or the NO button 330 in the reflection status setting column 306 of the condition setting unit 303 on the referral destination volume switching processing setting/execution screen 300, the CPU 20 proceeds to step SP155, and performs processing for reflecting the updated data in the logical volume VOL of the copy destination to the data in the logical volume VOL of the copy source according to the command of the selected YES button 329 or the NO button 330 (SP155).

Meanwhile, when the data stored in the primary volume VOL and the data stored in the secondary volume VOL coincide (SP151: YES), or when the “reflection” field 125 of the setting table 31 is “NO” (SP155: NO), the CPU 20 switches the access path from the secondary volume VOL to the primary volume VOL (SP156).

Specifically, the CPU 20, based on the path switching program 26, refers to the path connection information table 14 and changes the access path from the host system 2 to the secondary volume VOL to an access path from the host system 2 to the primary volume VOL. Pursuant to this change, the CPU 20 further changes the volume ID stored in the path switching program 26 of the volume management table 32 of the volume ID of the secondary volume, and changes the volume ID stored in the “secondary volume” field 101 to the volume ID of the primary volume.

When the reflection in the “reflection” field 125 of the setting table 31 is set to “YES” (SP155: YES), the CPU 20 controls the storage apparatus 3 so as to reflect the updated data stored in the secondary volume VOL to the primary volume VOL or another storage volume VOL.

Thus, by controlling the storage apparatus 3, the CPU 20 uses the CPU 41 (FIG. 2) of the storage apparatus 3 to set the volumes numbers of the primary volume VOL and the storage volume VOL respectively in the “copy source” field 129 and the “copy destination” field 130 of the copy management table 45, and copy data from the primary volume VOL to the storage volume VOL (SP162). Further, after the foregoing copy processing is complete, the CPU 20 deletes the volume numbers of the secondary volume VOL and the storage volume VOL respectively from the “copy source” field 129 and the “copy destination” field 130 of the copy management table 45.

Further, the CPU 20, based on the path switching program 26, refers to the path connection information table 14 and changes the access path from the host system 2 to the secondary volume VOL to an access path from the host system 2 to the storage volume VOL. Pursuant to this change, the CPU 20 further changes the volume IDs stored in the “primary volume” field 100 and the “secondary volume” field 101 of the volume management table 32, respectively (SP163). The CPU 20 further sets “in use” in the “used/unused” field 115 corresponding to the storage volume VOL in the hierarchy-based volume management table 30A or 30B (SP164).

Like this, by setting “in use” in the “used/unused” field 115 corresponding to the storage volume VOL, or when performing the path switching processing at step SP156, the CPU 20 is able to delete data from the secondary volume VOL since the data stored in the secondary volume VOL will not be referred to (SP157).

After deleting the data stored in the secondary volume VOL as described above, the CPU 20 sets “unused” in the “used/unused” field 115 corresponding to the secondary volume VOL of the hierarchy-based volume management table (high-speed volume) 30A (SP158). Simultaneously, the CPU 20 the storage apparatus 3 so as to delete the volume numbers of the primary volume VOL and the secondary volume VOL respectively from the “volume number” field 131 of the access management table 46 (SP159).

Subsequently, the CPU 20 deletes the pair status “2” from the “pair status” field 104 of the volume management table 32 (SP160), and deletes the volume numbers of the primary volume VOL and the secondary volume VOL from the “primary volume” field 100 and the “secondary volume” field 101 of the volume management table 32, respectively (SP161). The CPU 20 thereafter ends this non-pair type volume release processing.

### (2-2-5-6-3) Difference Type Volume Release Processing

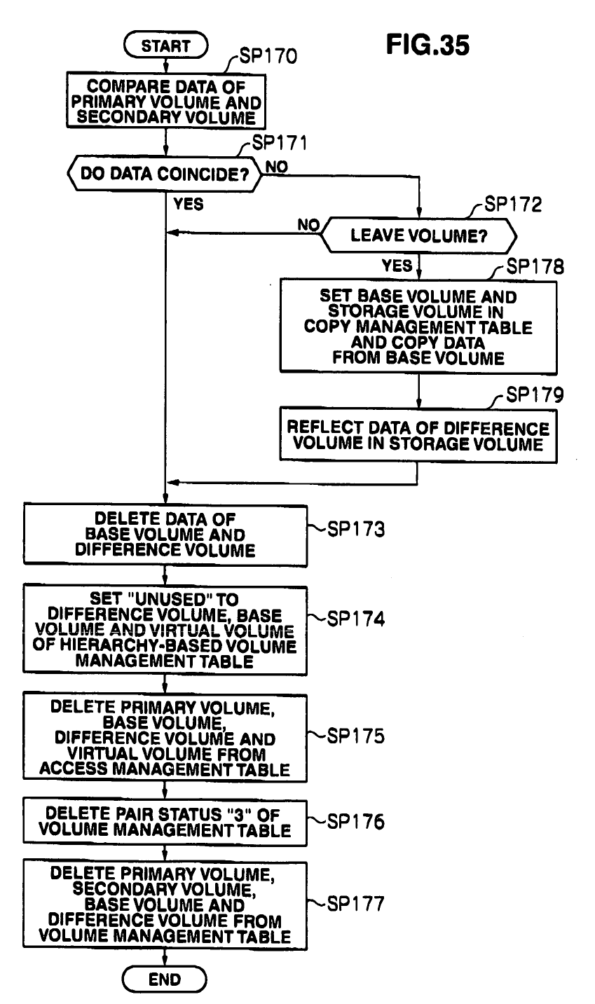

FIG. 35 is a flowchart showing the specific processing contents of the CPU 20 relating to the difference type volume release processing to be performed based on the difference type volume release processing program 24 activated at step SP134 of the volume release processing described with reference to FIG. 32. The CPU 20 executes, based on the difference type volume release processing program 24, the difference type volume release processing for releasing the copy pair of the difference type regarding the target logical volume VOL according to the processing routine shown in FIG. 34.

In other words, when the CPU 20 proceeds to step SP134 of the volume release processing (FIG. 32), it starts this difference type volume release processing, and foremost compares the data stored in the primary volume VOL and the data stored in the virtual volume VOL (SP170), and confirms whether such data coincide (SP171).

When it is determined that the data stored in the primary volume VOL and the data stored in the virtual volume VOL do not coincide (SP171: NO), the CPU 20 inquires the system administrator (user) to confirm whether to leave the virtual volume VOL (SP172).

When the system administrator decides to leave the virtual volume VOL (SP172: YES), the CPU 20 controls the storage apparatus 3 so as to set the volume numbers of the base volume VOL and the storage volume VOL as copy sources in the “copy source” field 129 and the “copy destination” field 130 of the copy management table 45, and uses the copy control program 42 to copy the data stored in the base volume VOL as the copy source to the storage volume VOL (SP178).

After this copy processing is complete, the CPU 20 deletes the volume numbers of the base volume VOL and the storage volume VOL as copy sources from the “copy source” field 129 and the “copy destination” field 130 of the copy management table 45, and further reflects the data stored in the difference volume VOL to the storage volume VOL (SP179).

When the data coincide as a result of comparing the data of the primary volume VOL and the secondary volume VOL at step SP171 (SP171: YES), or when the system administrator decides not to leave the virtual volume VOL (SP172: NO), or when the data of the difference volume VOL has already been reflected in the storage volume VOL (SP179), the CPU 20 performs the access path switching processing.

In other words, the CPU 20, based on the path switching program 26, refers to the path connection information table 14 and performs the access path switching processing. Specifically, when the data of the difference volume VOL has been reflected in the storage volume VOL, the CPU 20 changes the access path from the host system 2 to the virtual volume VOL to an access path from the host system 2 to the storage volume VOL.

Meanwhile, when the data coincide as a result of comparing the data of the primary volume VOL and the secondary volume VOL, or when the system administrator decides not to leave the virtual volume VOL, the CPU 20 changes the access path from the host system 2 to the virtual volume VOL to an access path from the host system 2 to the primary volume VOL. The CPU 20 thereafter deletes the data stored in the base volume VOL and the difference volume VOL (SP173).

Subsequently, the CPU 20 sets “unused” in the “used/unused” field 115 corresponding to the difference volume VOL, base volume VOL and virtual volume VOL of the high-speed hierarchy-based volume management table 30A or the low-speed hierarchy-based volume management table 30B (SP174). The CPU 20 further deletes the respective volume numbers of the primary volume VOL, base volume VOL, difference volume VOL and virtual volume VOL from the “volume number” field 131 of the access management table 46 (SP175).

Moreover, the CPU 20 deletes the pair status “3” from the “pair status” field 104 of the volume management table 32 (SP176), and deletes the volume IDs of the respective volumes VOL of primary volume VOL, secondary volume VOL, virtual volume VOL, base volume VOL and difference volume VOL respectively from the “primary volume” field 100, “secondary volume” field 101, “base volume” field 102 and “difference volume” field 103 of the volume management table 32 (SP177).

The CPU 20 stores an execution flag in the “execution” field 128 (sets “0” in the “execution” field 128) of the setting table 31, and changes the text displayed at a type display position (position at the row displaying the text of “Type” in the status display unit 340 of FIG. 13) associated with the logical volume VOL in the status display unit 340 of the referral destination volume switching processing setting/execution screen 300 from “difference type in execution” to “difference type”, and thereby ends the difference type volume release processing.

### (2-2-5-7) Pair Status Data I/O Processing

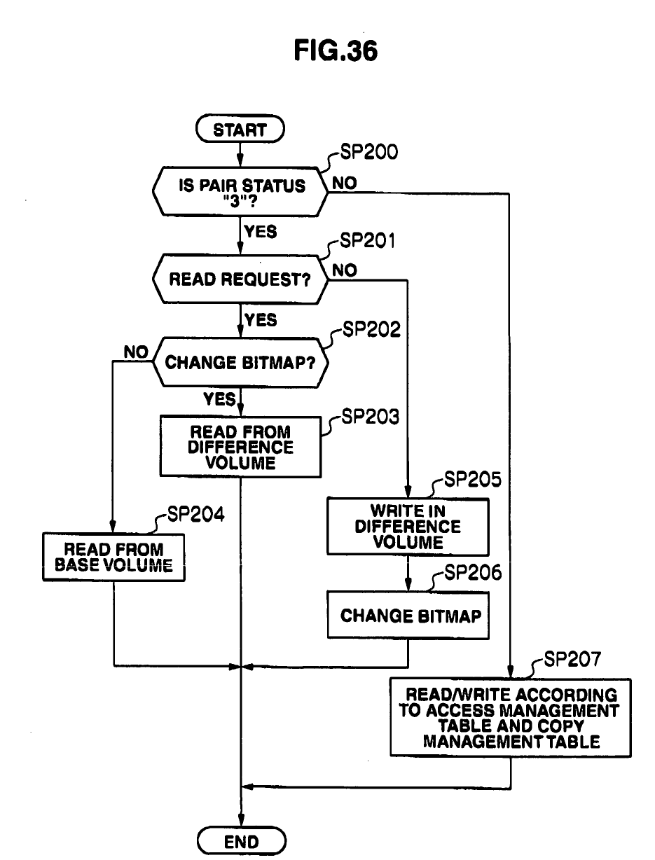

FIG. 36 is a flowchart showing the specific processing contents of the CPU 20 upon the respective host systems 2 inputting and outputting data to and from the respective logical volumes in the difference pair status.

The CPU 41 refers to the volume management table 32, and confirms that the pair status shown in the “pair status” field 104 of the volume management table 32 is “3” representing the difference type (SP200). When the CPU 41 confirms that “3” is designated as the pair status as result of referring to the volume management table 32 (SP200: YES), it confirms whether it is necessary to issue a data read request from the host system 2 to read data from the virtual volume VOL (SP201).

When the CPU 41 determines that it is necessary to issue a data read request for reading data from the virtual volume VOL (SP201: YES), the CPU 41 confirms the bitmap 210 (FIG. 23) associated with the virtual volume VOL in order to check whether the logical block corresponding to the virtual volume VOL has been changed (SP202).

When the CPU 41 confirms that the bitmap is “1”, since this means that the data has been changed (SP202: YES), it reads data from the difference volume VOL (SP203). Meanwhile, when the CPU 41 confirms that the bitmap is “0” (SP202: NO), since this means that the data has not been changed, it reads data from the base volume VOL (SP204), and ends the difference type data I/O processing.

Meanwhile, when there is no data read request for reading data from the virtual volume VOL (SP201: NO), the CPU 41 writes data in the difference volume VOL when there is a data write request (SP205), changes the contents of the bitmap 210 associated with the virtual volume VOL (SP206), and ends the difference type data I/O processing.

Contrarily, when the CPU 20 confirms that “3” is not designated as the pair status in the confirmation at step SP200 (SP200: NO), it reads and writes data according to the contents set in the access management table 46 and the copy management table 45 (SP207), and ends the difference type data I/O processing.

### (2-2-5-8) Path Switching Processing

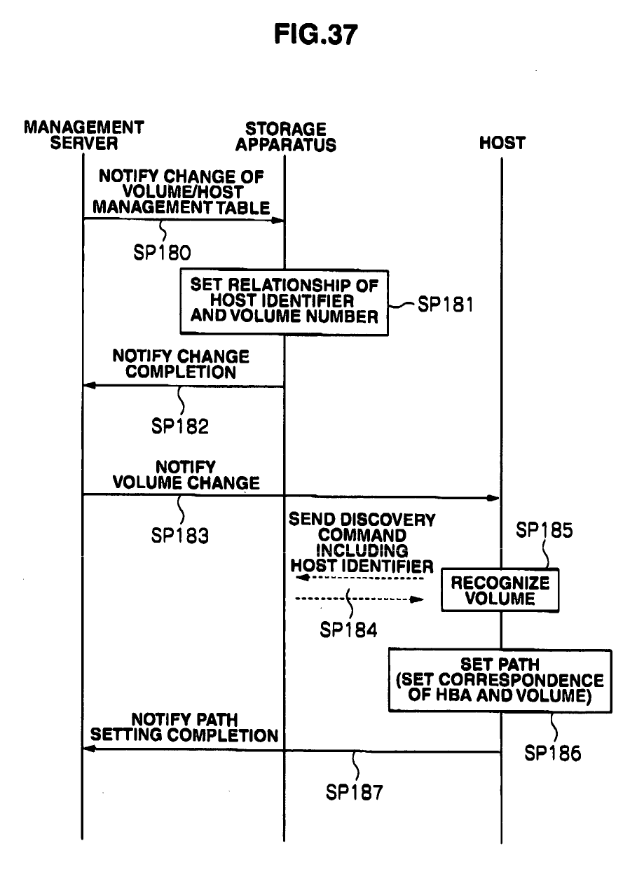

FIG. 37 is a flowchart showing the specific processing contents of the CPU 20 regarding the path switching processing to be performed in the volume creation processing program or the volume release processing program 24.

The path switching processing is performed by referring to the path connection information table 14 and the volume host management table 48 provided to the host system 2 based on the path switching program 26 in the management server 4. As the processing routine, foremost, the CPU 20 of the management server 4 issues a volume host management table change notice to the storage apparatus 3 (SP180).

The CPU 41 of the storage apparatus 3 sets the relationship of the host identifier and the logical volume VOL number by setting the data of the host identifier and the logical volume VOL stored in the “host identifier” field 136 and the “volume number” field 137 of the volume host management table 48 based on the volume host management table change notice (SP181). The CPU 41 of the storage apparatus 3 further notifies the management server 4 of the completion of such change when the change is complete (SP182).

When the CPU 20 of the management server 4 receives the foregoing change completion notice, it issues a logical volume VOL change notice to the host system 2 (SP183). Since the CPU 10 of the host system 2 will be able to recognize the changed logical volume VOL based on this notice (SP185), it sends a discovery command including information regarding the host identifier to the storage apparatus 3 (SP184).

Further, the CPU 10 of the host system 2 sets the path using the respective fields of “path identifier” field 105, “host port” field 106, “storage port” field 107 and “volume number” field 108 in the path connection information table 14; that is, it sets the correspondence between the host bus adapter 17 and the logical volume VOL (SP186). Moreover, when the CPU 10 of the host system 2 completes the setting of such path, it issues a path setting completion notice to the management server 4 (SP187). When this path switching processing is complete, the host system 2 will be able to perform I/O processing to the new logical volume VOL.

### (3) Effects of Present Embodiment

According to the present invention, it is possible to achieve the effect of reducing the load of the controller of the storage apparatus 3. Further, it is also possible to achieve the effect of realizing smooth responsiveness to the data I/O request since the storage capacity of the storage apparatus 3 will not be burdened, and the backup processing and the data I/O request from the host system 2 will not compete.

### (4) Other Embodiments

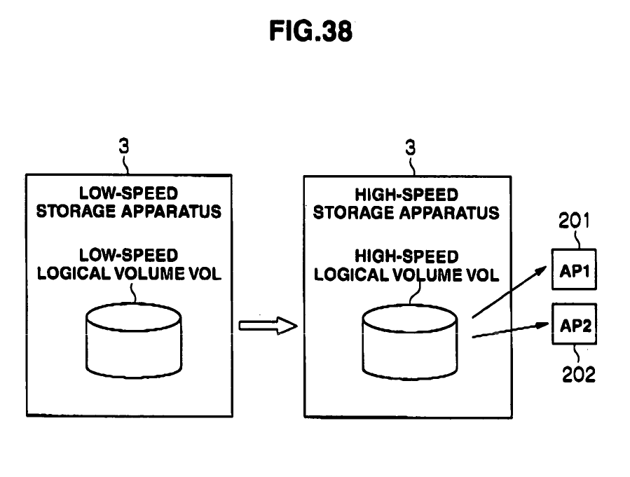

Incidentally, in the foregoing embodiments, although a case was explained where a low-speed logical volume VOL exists in an extent having a low response speed and a high-speed logical volume VOL exists in an extent having a high response speed in the same storage apparatus 3, the present invention is not limited thereto, and, as shown in FIG. 38, a low-speed logical volume VOL may exist in the low-speed storage apparatus 3 and a high-speed logical volume VOL may exist in the high-speed storage apparatus 3. In other words, the low-speed logical volume VOL and the high-speed logical volume VOL may respectively exist in separate storage apparatus having difference response speeds.

Further, in the foregoing embodiments, although a case was explained where the CPU 20 of the management server 4 or the CPU 10 of the host system 2 managed the decision of the copy source volume and decision of the copy destination volume, the present invention is not limited thereto, and the CPU 41 of the storage apparatus 3 may also manages such decisions.

### INDUSTRIAL APPLICABILITY

The present invention can be widely applied to a storage system including a storage apparatus.

I (We) claim:

1. A storage system having a host system as a higher-level device, and a storage apparatus providing a volume for said host system to write data, comprising:
an access frequency monitoring unit for monitoring the access frequency of said host system to said volume provided by said storage apparatus; and
a data management unit for managing the data written in said volume based on the monitoring result of said access frequency monitoring unit;
wherein said data management unit copies the data stored in said volume to a volume with a response speed that is faster than said volume when the access frequency of said host system to said volume exceeds a first default value;
switches the access destination of said host system to said volume of a copy source to said volume of a copy destination;
writes data to be written in both said volume of the copy destination and said volume of the copy source when there is a write access from said host system to said volume of the copy destination; and
returns the access destination of said host system to said volume of the copy source to said volume of the copy destination when the access frequency of said host system to said volume of the copy destination falls below a second default value.

2. The storage system according to claim 1,
wherein said data management unit deletes said data stored in said volume of the copy destination after returning the access destination of said host system to said volume of the copy source to said volume of the copy destination when the access frequency of said host system to said volume of the copy destination falls below a second default value.

3. The storage system according to claim 1,
wherein said data management unit copies the data stored in said volume to a volume with a response speed that is faster than said volume when the access frequency of said host system to said volume exceeds a first default value;
switches the access destination of said host system to said volume of a copy source to said volume of a copy destination;
writes data to be written in said volume of the copy destination when there is a write access from said host system to said volume of the copy destination; and
returns the access destination of said host system to said volume of the copy source to said volume of the copy destination when the access frequency of said host system to said volume of the copy destination falls below a second default value, and migrates the difference of the data stored in said volume of the copy source and the data stored in said volume of the copy destination to the original volume.

4. The storage system according to claim 1,
wherein said data management unit copies the data stored in said volume to a volume with a response speed that is faster than said volume when the access frequency of said host system to said volume exceeds a first default value;
switches the access destination of said host system to said volume of a copy source to said volume of a copy destination;
writes data to be written in said volume of the copy destination when there is a write access from said host system to said volume of the copy destination; and
returns the access destination of said host system to said volume of the copy source to said volume of the copy destination when the access frequency of said host system to said volume of the copy destination falls below a second default value, and stores the difference of the data stored in said volume of the copy source and the data stored in said volume of the copy destination in a prescribed volume.

5. A data management method in a storage system having a host system as a higher-level device, and a storage apparatus providing a volume for said host system to write data, comprising the steps of:
monitoring the access frequency of said host system to said volume provided by said storage apparatus; and
managing the data written in said volume based on the monitoring result of said access frequency monitoring unit;
wherein, at said managing step, the data stored in said volume is copied to a volume with a response speed that is faster than said volume when the access frequency of said host system to said volume exceeds a first default value;
the access destination of said host system to said volume of a copy source is switched to said volume of a copy destination;
data to be written is written in both said volume of the copy destination and said volume of the copy source when there is a write access from said host system to said volume of the copy destination; and
the access destination of said host system is returned to said volume of the copy source to said volume of the copy destination when the access frequency of said host system to said volume of the copy destination falls below a second default value.

6. The data management method according to claim 5,
wherein, at said managing step, said data stored in said volume of the copy destination is deleted after returning the access destination of said host system to said volume of the copy source to said volume of the copy destination when the access frequency of said host system to said volume of the copy destination falls below a second default value.

7. The data management method according to claim 5,
wherein, at said managing step, the data stored in said volume is copied to a volume with a response speed that is faster than said volume when the access frequency of said host system to said volume exceeds a first default value;
the access destination of said host system to said volume of a copy source is switched to said volume of a copy destination;
data to be written is written in said volume of the copy destination when there is a write access from said host system to said volume of the copy destination; and
the access destination of said host system to said volume of the copy source is returned to said volume of the copy destination when the access frequency of said host system to said volume of the copy destination falls below a second default value, and the difference of the data stored in said volume of the copy source and the data stored in said volume of the copy destination is migrated to the original volume.

8. The data management method according to claim 5,
wherein, at said managing step, the data stored in said volume is copied to a volume with a response speed that is faster than said volume when the access frequency of said host system to said volume exceeds a first default value;
the access destination of said host system to said volume of a copy source is switched to said volume of a copy destination;
data to be written is written in said volume of the copy destination when there is a write access from said host system to said volume of the copy destination; and
the access destination of said host system to said volume of the copy source is returned to said volume of the copy destination when the access frequency of said host system to said volume of the copy destination falls below a second default value, and the difference of the data stored in said volume of the copy source and the data stored in said volume of the copy destination is stored in a prescribed volume.
